(19) United States
(12) Patent Application Publication
(10) Pub. No.: US 2024/0129120 A1
(43) Pub. Date: Apr. 18, 2024

(54) DETERMINISTIC METHOD AND SYSTEM FOR GENERATING AN EPHEMERAL CRYPTOGRAPHIC KEY, A KEY ESTABLISHMENT PROTOCOL, ENCRYPTION SYSTEM AND METHOD, DECRYPTION SYSTEM AND METHOD, AND SYSTEM AND METHOD FOR STORAGE OF KEYING ELEMENTS AS AN OVERALL CRYPTOGRAPHIC SYSTEM

(71) Applicant: Jonathan Carr, Vienna, VA (US)

(72) Inventor: Jonathan Carr, Vienna, VA (US)

(73) Assignee: Black Spire, LLC, Vienna, VA (US)

(21) Appl. No.: 18/222,391

(22) Filed: Jul. 14, 2023

Related U.S. Application Data
(60) Provisional application No. 63/389,358, filed on Jul. 14, 2022.

(51) Int. Cl. H04L 9/08; G06F 21/60

(52) U.S. Cl. CPC H04L 9/088; G06F 21/602

(57) ABSTRACT

A deterministic encryption key generating method along with a cryptographic system is disclosed. The systems method uses the intersection of an equation representing a polynomial or quadratic (PQ-Equation) with a secure and secret 3-dimensional mathematical geometric shape, or manifold, to generate an ephemeral symmetric encryption key. Digital objects, files, and data can be cryptographically secured using this process with a unique per-file or per-data object key, which is destroyed after each use. The process combines coefficients of a PQ-Equation mapped onto the manifold to create or recreate the key from an identifier, for instance values for the PQ-Equation. PQ-Equation coefficients are stored with the protected file, accessible via the client and transmitted to the computational server possessing the secret manifold. The client device possesses no knowledge of the manifold and the computational server receives no knowledge of the digital object contents and no unitary key is stored, ensuring the confidentiality and integrity of the information being protected and allowing the digital object to be securely stored or transmitted over a network or the Internet with per protected data object defined access policies to the decryption key.

### CROSS-REFERENCE TO RELATED APPLICATIONS

This application claims the priority of U.S. provisional patent application 63/389,358, filed Jul. 14, 2022, which is incorporated herein by reference.

### COPYRIGHT NOTICE

Portions of the disclosure of this patent document contain material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### FIELD OF THE INVENTION

The present disclosure relates to a cryptographic system using polynomial or quadratic coefficients and a multi-variable geometric surface to generate a non-predictable but deterministic ephemeral or transient symmetric cryptographic key, which retains the full key-space and highest entropy, and is highly resistant to cryptographic analysis and brute-force attacks. The cryptographic system provides a way to apply access policies to encrypted data objects to aid in the management distribution of the cryptographic key to more securely control the decryption of the data object while also providing a wider range of applicable functions and resulting products.

### References

For the convenience of the reader, the publications referred to in the specification are listed below. In the specification, the patents are referred to by their patent numbers and the identifiers within parentheses refer to respective publications.

| Pat. No. | Issue Date | Inventors |
|---|---|---|
| 5,963,646 | October 1999 | Fielder et al. |
| 7,787,623 | October 2007 | Koichiro et al. |
| 8,311,215 | September 2010 | Koichiro et al. |
| 11,108,753 B2 | August 2021 | Murray et al. |

(Ref A) Dworkin, M., Barker, E., Nechvatal, J., Foti, J., Bassham, L., Roback, E. and Dray, J. (2001), Advanced Encryption Standard (AES), Federal Inf. Process. Stds. (NIST FIPS 197), National Institute of Standards and Technology, Gaithersburg, MD, (online), https://doi.org/10.6028/NIST.FIPS.197
(Ref B) Elaine Barker, Allen Roginsky, Richard Davis, (2020), NIST Special Publication 800-133 Revision 2. Recommendation for Cryptographic Key Generation. (online), https://nvlpubs.nist.govinistpubs/SpecialPublications/NIST.SP.800-133r2.pdf
(Ref C) Elaine Barker, John Kelsey (2015), NIST Special Publication 800-90A Revision 1. Recommendation for Random Number Generation Using Deterministic Random Bit Generators. (online), https://nvlpubs.nist.gov/nistpubs/SpecialPublications/NIST.SP.800-90Ar1.pdf
(Ref D) Elaine Barker, (2020), NIST Special Publication 800-57 Part 1 Revision 5. Recommendation for Key Management: Part 1—General. (online) https://nvlpubs.nist.gov/nistpubs/SpecialPublications/NIST.SP.800-57pt1r5.pdf
(Ref E) Ruiten E., (2021, Jan. 15). A Cryptosystem Based on Algebraic Surfaces. Universiteit Utrecht

### BACKGROUND OF THE INVENTION

Information systems and the digital information that they contain are considered to be critical assets that require protection. Information used by governments, businesses and consumers is often stored on computer systems comprising groups of interconnected computers that make use of shared networks, e.g., the Internet and shared network infrastructure, i.e., “the Cloud”. The continued evolution of technologies, e.g., distributed ledgers used in blockchain and the transformation and decentralization of the Internet with Web 3.0, pushes rapid and substantial sharing of such data even further by creating new data sharing efficiencies; however, these technologies increase security risks of accidental information exposure when information can be stored and accessed from anywhere by any user.

The desire to have unhindered and ubiquitous access to data, whether by a human using a desktop computer, a laptop, or a mobile device, or an automated computing system or artificially intelligent systems increases the burden on implementing secure information processes to permit the widest available and most accessible use of stored information securely as needed.

A digital society demands that digital data and electronic information, referred herein to as Data Objects (DO), held in computer systems, networks, and/or the Cloud must be accessible such that its accessibility be efficient and secure and commonly made available through a network access or is easily shared using email, message services, and file sharing services. The devices that create, use, transmit or receive the data object can be mobile or stationary. While unhindered and ubiquitous access is desired, the data owner or recipient may have special handling policies and security needs for the information transmitted, received and stored; thus, making data security management complicated, cumbersome, ineffective or ignored.

Information security requirements, derived from organizational policies for protecting Personally Identifying Information (PII) and other personal, corporate and government proprietary or classified government data, become even more challenging with a highly mobile workforce exposed to this pervasive demand for digital access, where data is often stored in shared network environments or accessed on untrusted mobile devices. The information used by these systems requires protection when at rest, when being processed within a protected facility, and when transported from one location to another. Insiders and threat actors may bring significant harm to the organization should they have physical or logical access to stored data; or inadvertently release owing to a loss or spill of data due to mishandling of the data objects or a misconfigured network.

Cryptography provides a layer of protection and is often used to protect information from unauthorized disclosure, to detect unauthorized modification, and to authenticate the identities of system entities (e.g., individuals, organizations, devices or processes). Cryptography is particularly useful when data transmission or entity authentication occurs over communications networks for which physical means of protection (i.e., physical security techniques) are often cost-prohibitive or even impossible to implement. Thus, cryptography is widely used when business is conducted or when sensitive information is transmitted over the Internet. Cryptography provides a layer of protection against insiders and hackers who may have physical or logical access to stored data, but not the authorization to know or modify the data. The challenge with cryptography is providing a meaningful and efficient way to secure the data without encumbering access to or transmission of the data, is accessible by authorized users and computing processes, and is not restricted by the computing or electronic device used, while ensuring that the available key protection system is robust, encompassing all available cryptographic keys in the algorithms cryptographic key space.

A widely accepted technique of protecting information stored in an information system or communicated over networks is the use of cryptography and data encryption. Cryptography can be used to provide three major types of protection to data: confidentiality, integrity, and source authentication. Confidentiality protection protects data from unauthorized disclosure; integrity protection provides mechanisms to detect unauthorized data modifications; and source authentication provides assurance that the protected data came from an authorized entity. Data encryption technology can be classified generally within two methods: symmetric-key cryptography and asymmetric encryption methods.

Symmetric-key cryptography is an encryption method where only one key, which must be kept secret, is used to encrypt and decrypt a message. This method is commonly used in banking and data storage applications to protect stored data. Examples of symmetric-key cryptographic algorithms include for example, but are not limited to, Data Encryption Standard (DES), the Rivest's Cipher (RC) family of algorithms, the Rijndael algorithm—also known as the Advanced Encryption Standard (AES)—Blowfish, International Data Encryption Algorithm (IDEA), and others.

Asymmetric cryptography or public key cryptography differs from symmetric-key cryptography in that a public key—which may be known to others, is used to encrypt a message, and a private key, which remains secret, can decrypt the message, while, with symmetric key encryption, no key(s) is publicly shared. Examples of asymmetric encryption algorithms include, for example but are not limited to Rivest-Shamir-Adleman (RSA) and Elliptic Curve Cryptography (ECC). Asymmetric encryption methods generate a public and private key and are generally based on mathematical properties of prime numbers. In both cases, proper management of the cryptographic keys is essential to the safe use of encryption. Loss of the keys can lead to loss of data and exposure of an organization to violations of compliance requirements.

Cryptography further generally relies on two basic components; 1) an algorithm, or cryptographic method, and, often used but sometimes optional, 2) cryptographic key (Kᵢ). The algorithm is a mathematical process and the cryptographic key is a parameter used by that process. Mathematical algorithms, human interaction, natural processes and machine state properties are used to produce bits of information that form the key. The output of a Random Bit Generator (RBG), the derivation of a key from another key, and the derivation of a key from a password, are methods used to transform the bits of information into cryptographic keys.

Generally, all keys are based directly or indirectly on the output of an approved Random Bit Generator (RBG), for instance that which is described by NIST Special Publication (SP) 800-133 Revision 2, Recommendation for Cryptographic Key Generation, (NIST SP 800-133 Rev. 2) (Ref B herein above), which is incorporated herein by reference, or a Deterministic Random Bit Generator (DRBG), for instance that which is described in NIST SP 800-90A Rev. 1 (Ref C herein above) which is also incorporated by reference herein, or a Pseudo-Random Number Generator (PRNG) or similar algorithm or engine. A DRBG or PRNG algorithm that produces a sequence of bits from an initial value is determined by a number used to initialize the DRBG or PRNG, referred to as a seed, which is determined from the output of the randomness source. Once the seed is provided and the initial value is determined, the DRBG is said to be instantiated and can be used to produce output. As long as the seed is kept secret, and the algorithm is well designed, the bits output by the DRBG will be unpredictable, up to the instantiated security strength of the DRBG.

Symmetric keys can be produced by combining multiple keys and other data, as shown in NIST SP 800-133 Rev. 2, which is incorporated by reference. When symmetric keys (K₁, . . . Kₙ) are generated and/or established independently, they can be combined within a key-generating module to form the input key, Kᵢ. Other data (D₁, . . . Dₘ) can be generated using methods that ensure their independence from Kᵢ and can be combined with Kᵢ to generate a new key.

A modern cryptographic method, or cipher widely in use is the Advanced Encryption Standard (AES), NIST FIPS Pub 197, November 2001, (FIPS 197), (Ref A listed above) which is herein incorporated by reference and used in an exemplary embodiment of the instant disclosure. The AES standard specifies the Rijndael algorithm, which is a symmetric block cipher algorithm. The AES cipher uses an input key to generate a set of keys by the key expansion routine. Plaintext (P) data, which can be a message, data file or other information, along with the cryptographic key (Kᵢ) is inputted into the AES cipher algorithm (E) to transform the information into Ciphertext (C), through the encryption process C=E(Kᵢ, P). Encrypted information is unreadable without passing the Ciphertext and Kᵢ into the AES cipher inverse algorithm (D), transforming the Ciphertext back into Plaintext; the decryption processes defined as P=D(Kᵢ, C). The cryptographic key used to encrypt P to C and C to P is the same key; therefore, Kᵢ is symmetric.

Key information must be protected for the security services to be “meaningful.” NIST SP 800-57 Part 1 Rev. 5, Recommendation for Key Management: Part 1—General. One method to store and manage cryptographic keys is by using a Cryptographic Key Management System (CKMS). Within a CKMS, all keys are stored in a database, whose security is reliant on implemented security practices by the user and organization. Although a CKMS can be secure when proper security is implemented, the fact that a CKMS stores all cryptographic keys for the organization, makes CKMS's attractive targets for improper actors, criminals, and hackers. Computing systems with zero-day vulnerabilities or unpatched systems result in weakened security, providing opportunities for the actors to access the CKMS and steal the keys.

An example of typical per file encryption in prior art is the deterministic key generators and CKMS solution that maps a precomputed key or seed, like that shown in U.S. Pat. No. 5,963,646, to an object, such as a file or digital information. The '646 patent shows a prior art solution in that the disclosed encryption method is a method and system for generating a deterministic but non-predicable symmetric encryption key. This method combines two values, bits of a constant value or message, e.g. Other Data, logically, cryptographically and/or algebraically combined with the bits of a secret plural bit sequence (E-KEY SEED). Although the E-KEY SEED is held secret, the E-KEY SEEDs are stored in a key directory and mapped to an object to be encrypted or decrypted. Because the data file is mapped to an E-KEY SEED stored in a database, or CKMS, the encrypted file cannot be easily transmitted to a third party without a method to share the encryption key or provide access to the database storing the E-KEY SEED. A shortcoming of this method is the size of key space that is practically available for use. AES 256 comes in several standards, 128-bit, 192-bit and 256-bit implementations. The theoretical maximum storage space for the full AES 256 key space is approximately 1.5E65 terabytes. Although this method uses Other Data in an attempt to provide additional system entropy computed with the E-KEY SEED, an inherent weakness in this system is that Other Data is derived from the bits of the message being protected and therefore, is known and therefore discoverable and a vector for attack. NIST SP 800-133 Rev. 2 allows for Other Data to be used to compute K, when Other Data is independent from the key. In this case, the bit of the message is known and is not independent when combined with the E-KEY SEED, which results in a weakening of the key and decreasing the encryption system entropy. To retain maximum system entropy, one E-KEY SEED must be mapped to one file. In large file systems, the number of E-KEY SEEDS must grow with the number of files in the system. Storage and processing limitation may force one E-KEY SEED to be used for many files, where key reuse decreases system entropy and weakens the key over time. Additionally, E-KEY SEEDS are derived from a single ACTIVATION CODE. As system entropy and randomness decreases, there is increased probability that the ACTIVATION CODE can be computed by improper actors, criminals and hackers, which would permit the calculation of all E-KEY SEEDS used by the method of the '646 patent. Therefore, no meaningful barrier against discovery of the E-KEY SEED and the ACTIVATION CODE can be provided for the described encryption system. The ease in discovery makes this method/system impracticable and dangerous for the use in high security environments.

U.S. Pat. No. 11,108,753 B2 discloses an encryption system in which the disclosed method uses a per-file key (FK) management and encryption methodology. This method generates a per-file symmetric key FK and secures FK using a wrapping key (WK). WK can be configured to be shared between files of a directory or a directory tree. File and directory access configurations are contained in a security/configuration policy and CKMS, managed by a policy engine. WK's are stored in a key manager, securely communicating with the policy engine. This method permits the generation of a single FK per file, allowing per file encryption. However, as the number of files, directories, users and resources requiring file access increase on the storage system the number of FK's and WK's will exponentially increase. Storage and computing limitations will limit the number of possible keys for per-file encryption to significantly less than the 2²⁵⁶ potential key space. As the number of users and resources increase within the system sharing the same access policy, the WK key will be mapped one to many, which will decrease entropy in the system and weaken the wrapper keys, resulting in a lowering of the protection and robustness of the encryption method, allowing improper actors, criminals and hackers to exploit the weak key vulnerability to recompute the wrapper and file keys.

U.S. Pat. No. 7,787,623 shows an encryption method which proposes a key generating apparatus and method to improve upon a public-key cryptography using an algebraic surface, referred to as an algebraic surface cryptosystem. Public-key cryptography, or asymmetric cryptography, differs from symmetric key cryptography, where a public key, which may be known to others, is used to encrypt a message, and a private key, which remains secret, can decrypt the message. In symmetric key encryption, the key is not publicly shared. In this method, an algebraic surface defined as a topological space having two-dimensional degrees of freedom in a set of solutions of simultaneous (algebraic) equations is defined by a finite algebraic field, K. X: f(x, y, z) are algebraic surfaces in the field, while X(x, y, z)=0 is a specific algebraic surface in field K. A plurality of algebraic curves represented by D₁: (uₓ(t), u_{y}(t), t), D₂: (vₓ(t), v_{y}(t), t) and Xₜ₀ represent divisors on the algebraic surface. Although this method utilizes algebraic surface to support the computation of encryption keys, this method uses finite fields and surfaces differing from the proposed method, which uses geometric manifolds. This method uses a plurality of polynomials representing algebraic curves, acting as divisors, to generate two keys, a public and private key, which differs from the proposed method which can use a polynomial or quadratic equation to solve for a unique point on the manifold surface to act as an unknown data source for a seed supplied to the key generating equation to generate a deterministic symmetric key. Furthermore, this method is based on public/private key pairing; therefore, the private keys must be stored in a CKMS to ensure proper pairing and to retain the ability to decrypt the information, resulting in a less secure system vulnerable to attack.

U.S. Pat. No. 8,311,215 is based upon and claims the benefit from prior U.S. Pat. No. 7,787,623 and extends the public-key cryptographic method to include an encryption apparatus, a decryption apparatus and a storage medium and (Ruiten, 2020). The encryption key generation method is a public/private key generation method based on an algebraic surface as described in U.S. Pat. No. 7,787,623. The encryption and decryption apparatus describe the implementation algebraic surface cryptography, to reduce the burden on the factorization process to realize the efficiency of the entire encryption or decryption process. This process is not a deterministic symmetric key encryption system and the keys must be retained for the duration of their required existence leaving them vulnerable to discovery.

The exemplary embodiments of the disclosure include a cryptographic system and corresponding method of encryption. The cryptographic system improves information security by implementing a unique key establishment protocol and process to compute a symmetric cryptographic key for the minimum duration of encrypting a data object or decrypting a protected data object, then destroying or rendering unusable the key or otherwise requiring no storage method to retain the key. The key establishment protocol is a component of the system and a method to generate and regenerate a deterministic cryptographic key, whose process retains the highest entropy in key randomization and the full spectrum of the cryptographic key space without storage of, securing of, and/or maintenance of a key store. Further, the disclosure describes how coefficient properties can be locally stored within the protected data object, ensuring the protected data object is secure and can be stored securely or transmitted without having to provide or manage cryptographic key material. The disclosure describes how the key establishment protocol components of the system and related methods are provided to the key generating service, a component of the exemplary embodiments of the disclosure, to recompute the symmetric key. Further, the disclosure describes a method to apply, associate, and attach access policies, rules and procedures used to protect the automation and provisioning of the Transient Cryptographic Key to the requesting client, in order to regulate who or what is authorized to receive the cryptographic key. An additional advantageous aspect of the exemplary embodiments of the disclosure are that the cryptographic system is indifferent to the encryption method and can use existing encryption schemes, such as, but not limited to, the Advanced Encryption Standard (AES), Blowfish, Rivest Cipher, and Data Encryption Standard (DES) and the like.

The instant disclosure provides a system and method whereby the cryptographic key is not stored, rather, once used to encrypt a data object into a protected data object, the key is destroyed or rendered unavailable, thus the key is ephemeral or transient. The system provides a method where the key can be deterministically recomputed, to decrypt a protected data object; therefore, this method renders key storage unnecessary. An additional aspect of this cryptographic system is that it allows a data object to be protected and secured using blockchain smart contracts and attestation of ownership using Non-Fungible Tokens (NFT) as a component of the policies. This cryptographic system provides per-data object encryption and is indifferent to the method of transmittal and storage of the protected data object, allowing for local storage, network storage, cloud storage, storage on the blockchain or a decentralized file system, e.g., the InterPlanetary File System (IPFS) as non-limiting examples.

### SUMMARY OF THE INVENTION

In view of the limitations of the prior art, an apparatus, device, engine, and methods, identified as a system, subsystems and protocols, components, objects services or elements of the subsystem, are disclosed to secure digital data objects and digital information using symmetric key cryptography whereby the key is transient for encryption and rendered inaccessible as a complete encryption key after initial encryption. The Transient Cryptographic Key, used to decrypt the encrypted digital data object, can only being reconstituted based on multivariate properties generated using a complex manifold subsystem and resulting point solutions used to transform component keys into the Transient Cryptographic Key.

The instant invention according to the noted aspects, the figures, claims, and the description are described in relation to one or more exemplary embodiment of the apparatus, system and method of operation of the system; however, the invention can also be realized not only as a system but also a computer enabled program, a method, or a computer readable storage medium with said program thereon, a device, a specialized computer or controller, and similar devices as a matter of course.

The invention according to the noted aspects and figures is comprised as a group of elements, objects, processes, and services to form components and methods, where components and methods function together idealized as a subsystem and protocol. In this inventions embodiment, subsystems function together across their functional boundary at interfaces using protocols to form a system.

The instances of this inventions, the system can include but is not limited to a deterministic cryptographic key generation method, a key establishment protocol, access policies, an encryption method and decryption method, and a method to securely protect a data object as a protected data object.

This invention, according to the noted aspects, identifies DOs such as but not limited to, digital information, data files, data collections, data documents and electronic information in any format; unencrypted, encrypted, partially encrypted, encoded or not encoded. A DO can be any storage or data unit that contains a value or group of values describing data. Every value can be accessed using its identifier or a more complex expression that refers to the data object as a part of a file system. The specific file type is not defined, but can include for example, but is not limited to, documents, multimedia, code components, directory, library, and similar data types. Additionally, each object may have different data types or multiple data types or single data types.

An aspect of the present invention is the Protected Data Object (PDO). The PDO is itself a data object and the computing and information system can treat it as such; however, the PDO is created through a data packaging method, such as but not limited to a file archiver, and possesses additional information and metadata to adhere to the intent of this invention. The PDO includes, but is not limited to, the polynomial and quadratic equation coefficients (PQC), access policies in encrypted form (C_{Policy}), and DOs in encrypted form (C_{DO}). A primary benefit of the PDO is to ensure confidentiality, integrity and authenticity of the data, secured through encryption methods without the need for managing a cryptographic key(s). This method permits the PDO to be securely stored and, or transmitted without having to manage or securely transmit the key. A further aspect of the PDO is the ability to link the PDO to a block on a blockchain, and assigning a Non-Fungible Token (NFT) to the object for the attestation of authenticity to a person or organization.

The invention enables per-DO security, including individual data files, data collections, data documents, and the like, by protecting each object through the use of encryption, each with a unique cryptographic key, to achieve a high level of security while operating in trusted, semi-trusted, and non-trusted environments. In an exemplary embodiment, this is done in near real-time, however, it can also be done in less than real-time without departing from the spirit of the invention.

The invention enables the generation of a deterministic cryptographic key. The protocol of the invention does not require storage of the key; therefore, the cryptographic key is short-lived; transitory, or ephemeral; generated by the method, used to encrypt or decrypt the DO, then destroyed or rendered unusable. This method can retain the entirety of the AES 256 cryptographic key-space at affordable computational and storage costs, allowing the highest entropy to remain in the system throughout its lifetime. The system is indifferent to the symmetric encryption algorithm type.

The invention idealizes a key establishment protocol, which is embodied in an exemplary embodiment as a method and hardware including but not limited to an encryption engine and a manifold engine, collectively the server subsystem, and a client subsystem to create and provision the cryptographic key to the requesting client. This differs from key agreement protocols, which are generally found in asymmetric encryption methods, and is intended to prevent third parties from eavesdropping on data transmissions. This invention does not preclude the use of a key agreement protocol to pass information between the Client Subsystem to the Server Subsystem; however, the key establishment protocol includes a method that incorporates access policies to ensure the requesting client is authorized to receive the cryptographic key. If the access policy is met, then key generating service provisions the cryptographic key to the client, otherwise, the key is not provided.

A still further aspect of the invention idealizes access policies as part of the key establishment protocol, which contain the rules and procedures used to automate the provisioning of the cryptographic key to the requesting client. Access policies, can also be described as policies and smart policies, they can be user or process selected and are stored as an encrypted data block in the Protected Data Object as C_{Policy} as described in greater detail herein below. The C_{Policy} data block is provided to the key generating service for example, which decrypts the policy once the cryptographic key has been recomputed and executes the rule and procedure(s) to follow. If the access policy has been met, then the key generating service provisions the cryptographic key (Kᵢ) to the requesting client. This method provides a robust way to regulate who or what is authorized to receive the cryptographic key whilst maintaining significant security around the key provisioning service, whose elements are not available outside the server, and not storing the key in a typical fashion.

An aspect of the present invention is the key establishment protocol, which can accommodate decentralized services, blockchain smart contracts protocols and Non-Fungible Tokens (NFTs) for a wider range of applicable functions and resulting products. Decentralized services typically utilize a permissionless structure that enables services distributed or delegated away from a central, authoritative location or group. The InterPlanetary File System (IPFS), is a protocol and peer-to-peer network for storing and sharing data in a distributed file system, anywhere and on any device or storage system, thereby providing decentralized file systems. A “smart contract” is a computer protocol intended to digitally facilitate, verify, or enforce the negotiation or performance of a contract and can allow the performance of credible transactions without third parties. Non-fungible tokens (NFTs) are cryptographic assets on a blockchain with unique identification codes and metadata that distinguish them from each other. The key establishment protocol enhances data object security in a distributed file system since the DO can be protected through cryptographic systems, while the key used to encrypt the DO does not require it to save, stored or remain in existence. Access policies can be built into smart contracts to function with the key establishment protocol to call the key generating service when the smart contract has been fulfilled.

Ensuring authenticity of the file is paramount in a distributed file system; therefore, NFTs can be used to associate a cryptographic identification to the Protected Data Object to attest to the objects authenticity. Enhanced security can be provided by applying the methods of the invention and including as part of the performance of the apparatus of the invention in conjunction with blockchain technologies. Specifically, the PQC data or other identifier can be stored on the blockchain node for security and identification and a pointer or other location identifier back to the node applied as the transmitted identifier to retrieve the PQC from the blockchain. This adds an even further layer of security to the transmitted data beyond those discussed herein.

An aspect of the present invention is the provision of a cryptographic system having a secret 3-dimension mathematical geometric shape, referred to as a Manifold (M) herein, stored securely on a computing device, referred to as the Server Subsystem, as an integral part of the cryptographic key generating engine used in the subsystem and executing the method of the instant invention to provide a more secure encryption methodology.

According to the instant invention, the manifold, through the hardware for generating and storing it and through communication with the cryptographic system, provides a compact topological surface, generally idealized as a manifold with a boundary, which is locally Euclidean. The manifold (M) can be described as, but is certainly not limited to, a sphere, torus, double torus, cross surface, a Klein Bottle, Riemannian, Kähler, a Calabi Yau, and similar shapes or algorithmic expressions. The complexity of the manifold is derived by the inputs into M, where a user or system function can select the manifold type and its properties to generate a unique manifold for the purpose of this invention. The manifold surfaces are transformed into a mesh-like surface, called surface facets, where each closed mesh surface represents a facet of the surface.

An aspect of the present invention are the manifold facets. A facet can be represented as, but not exclusive of, a planar surface comprising of three or more vertexes. When all facets are assembled, they represent a coarse idealization of M. An aspect of the facet is a unique and secret component key, called a Key Seed (KS), which is used as one component of the method to compute the cryptographic key. A unique KS is computed for each manifold facet and is securely stored and held secret in a Manifold Table Object (MTO).

Yet another aspect of the present invention is the provision of one or more Manifold Table Object(s) (MTO), which store(s), at a minimum, details of one or more manifolds, the manifold facets and the associated Key Seeds. The MTO is part of a set of data that stores the representation of the manifold, accessible by the key generating service, but generally not directly accessible by the client process. This separation enhances security by distributing the key component data, such that Kᵢ cannot be computed without the key generating service receiving the polynomial-quadratic equation coefficients (PQC) from the PDO and the KS and facet from the MTO.

A further aspect of the present invention is the Polynomial or Quadratic Equation (PQ-Equation), wherein, the PQ-Equation can be for example, but is not limited to, a linear, a non-linear, an open or closed shape in one or more dimensions with the complexity of the PQ-Equation driven by the inputs into the PQ-Equation and wherein a user or system function can select the equation type and its properties to generate a unique PQ-Equation for the purposes of the instant invention. The PQ-Equation is mathematically computed into the 3-dimension space of the secret manifold, such that a minimum of one point on the PQ-Equation intersects perpendicularly to a facet of M in the key generating service to generate exclusive points on M.

An aspect of the present invention is the PQ-Equation coefficients (PQC(s)). PQC represents the coefficients which are provided to the key generating service to compute the idealized mathematical polynomial or quadratic equation into the 3-dimensional space with the Manifold. The PQC is computed when the first computation of the cryptographic key is made and provided to the client to be stored within the Protected Data Object (PDO). The PQC is provided to the key generating service as one component of the method to recompute the key. PQCs are considered a type of Other Data, whose values need not be kept secret; however, they can be cryptographically secured. In the case of one type of PQ-Equation, as represented by a sphere, coefficients can include, for example, but are certainly not limited to the sphere's center point in 3-dimensional space and the sphere's radius. These coefficients allow the PQ-Equation generator to accurately plot the equation onto the secret manifold, identify the surface facet in the Manifold Table Object and compute the Surface Perpendicular Point (SPP).

From the perspective of improper actors, criminals and hackers, knowledge of the PQC only allows them to derive the fact that a polynomial or quadratic equation exists in 3-dimensional space. This knowledge does not reveal any detail of the manifold nor information that would expose the facet and the SPP which is required to compute the cryptographic key. Furthermore, by including the PQC with the protected document, the key generating service cannot compute the cryptographic key without the coefficients, ensuring the security of the protected document and secrecy of its contents.

An aspect of the invention is the Surface Perpendicular Point (SPP), which is a point on the manifold where the PQ-Equation is uniquely perpendicular to the manifold and can be recomputed by the key generating service with the PQC. The PQ-Equation can intersect the manifold at an n-number of exclusive perpendicular locations; however, SPP is determined by the PQC when applied to the PQ-Equation and mapped onto the manifold.

A still further aspect of the present invention is a key generating service, which can be identified as a method, a process, or engine, which deterministically generates and regenerates a Symmetric Transient Cryptographic Key (Kᵢ) of appropriate length for the encryption process being used within the encryption engine. The Transient Cryptographic Key (Kᵢ), also identified as key or transient key, which is used to encrypt the DO into a PDO and to decrypt the PDO into an accessible data object which is computed using two or more component keys combined through a process of concatenation, Exclusive-Oring or a combination of both. The components compute the PQ-Equation into the 3-dimensional space of the manifold to mathematically identify the unique point SPP, representing the intersection of the PQ-Equation onto the manifold. The properties of the SPP, along with the properties of the PQ-Equation coefficients used in the calculation and the facet's KS are combined through a hashing function to produce Kᵢ. The properties of each component key, K₁, K₂ and K₃ are made of sufficiently unique data, such that when combined, they can allow the computation of the maximum key space, Kᵢ, permitted by the encryption algorithm.

In the exemplary embodiment shown, the three component keys; K₁, K₂ and K₃ are computed, then combined to create Kᵢ. K₁ is computed when the PQC is passed through a secure hash function. K₂ is computed when the SPP is passed through a secure hash function. K₃ is computed when the secret Key Seed (Kₛ) is passed through a secure hash function. K₃ which relies on the key seed (Kₛ) acts as a cryptographic salt to mitigate hash table style attacks by ensuring that any attacker who could use ultra-high performance computing systems to calculate the entirety of the K₂ component key space, still has no reasonable chance to re-compute Kᵢ for a PDO. When cryptographically combined, K₁, K₂ and K₃, the Transient Cryptographic Key (Kᵢ) can be deterministically computed while maintaining the entropy and maximum key-space possible afforded by the encryption algorithm. To ensure secrecy of the key, the SPP is destroyed after computing Kᵢ, rendering recomputing Kᵢ impractical without full knowledge of the several keys used by the method and system components for the given transient key.

A further aspect of the instant invention is a robust protocol to manage the request to create, recreate and provision the cryptographic key, Kᵢ. The properties of the component keys are mathematically computed in a deterministic way, allowing Kᵢ to be recomputed as needed. Since Kᵢ can be recomputed, using the methods and protocols described, Kᵢ can be treated as an ephemeral or transient key, rendering key storage methods unnecessary.

A further aspect of the instant invention allows each data object (DO) to be encrypted with a unique Kᵢ, permitting per-DO encryption without reusing the key. In addition to a unique per-DO Kᵢ, the protocol provides a method by which a single data object can be encrypted with a new Transient Cryptographic Key each time the request to protect is made, e.g., save from unencrypted DO to a PDO. This permits a single DO, whose information and raw data contents may be updated over time to be protected uniquely from its previous instantiation.

A further aspect of the instant invention are access policies, also referred to as policies, which represent guidelines to a Policy Actions process, which implement procedures to achieve an intended outcome for returning the Transient Cryptographic Key to the requesting client. Access policies are actions, such as, but certainly not limited to, ‘Open by Smart Contract’, ‘Do Not Open Before Date’, ‘Open by Phone Number’, ‘Open by Devices’, and the like. The access policies can be selectable by a user, process or by other methods. Access policies are protected as an encrypted data block inside the PDO to ensure policy integrity. When a PDO is requested for access as a DO, the polynomial and quadratic coefficients, along with the encrypted policy data block, representing the access policy, are provided to the key generating service. Once Kᵢ has been computed, but before it is returned to the client to decrypt the PDO, the Policy Actions process decrypts the encrypted policy data block and executes the policy action.

In an exemplary embodiment, the ‘Open by Smart Contract’ access policy can be incorporated into blockchain smart contract technology to fulfill a programmed purpose, before the Policy Action process would release Kᵢ to the client. This policy action provides, but certainly is not limited to, the release of Kᵢ for data object saved across a distributed platform. A further aspect of this embodiment is associating the data object with a Non-Fungible Token (NFT) for attestation of authenticity. Examples of the use of this policy action in connection with blockchain smart contracts and NFT's include, but are certainly not limited to, a legal document, such as a persons will that spells out the legal wishes regarding the care of children, as well as the distribution of assets after death. A blockchain smart contract can be used to initiate a request for Kᵢ from the systems key generating service, upon death, to decrypt the contents of the PDO into the will, while the NFT can be used to attest the DO, or will's, ownership as a valid and legal document. In addition to, corporations filing Security and Exchange Commission (SEC) filings can use this systems methods and processes to secure their corporate filing from an inadvertent or maligned exposure when prepared, and use the blockchain and NFT's to execute and release the filing publicly per the filing schedule. This method permits documents to be released publicly be kept secure and confidential until the appropriate time for release has been met.

In an exemplary embodiment, the ‘Do Not Open Before Date’ access policy can protect the PDO from being decrypted and viewed, by ensuring the requesting client does not receive Kᵢ before the date as described in the policy. This policy action provides, but is certainly not limited to, a contract proposal for a public works project, when the proposal must be delivered by a certain date but not after a certain time. However, by delivering the proposal early, a corrupt individual or mismanaged document storage could result in the leak of proposal data, allowing a competitor to submit a proposal with knowledge of the leaked data. By applying an access policy which prevents the protected data object to be viewed in its unprotected format, the proposal window would be closed to further submission before the PDO's could be viewed.

In an exemplary embodiment, the ‘Open by Phone Number’ access policy can be used as an add additional layer of security when a PDO is transmitted or otherwise provided to another party. An example use of this policy action provides, but is certainly not limited to, a method by which the receiving party may receive a digital token by Short Messaging Service (SMS) or other secure messaging method to validate that the receiving party. The token would be provided by the receiving party to the Policy Actions process before release of Kᵢ.

In an exemplary embodiment, the ‘Open by Devices’ access policy can be used as an additional layer of security to restrict providing Kᵢ to an approved client or process. This policy action provides, but certainly is not limited to, the release of Kᵢ for a PDO to specific device(s) or process. An example of the use of this policy action would be to protect queries and computational results used on large sets of data, or big data. Use cases, including but not limited to, searching health records and Personally Identifiable Information (PII) by institutions, government entities, researchers, etc., may desire their query criteria and the findings to remain confidential when working with open-source and commercial data. This method can restrict providing Kᵢ to specific devices and processes, such that only those devices and processes authorized to read the query to run against the data and read the results from the query can decrypt the protected data object.

Yet a further aspect of the present invention is the client subsystem, which is provided to users or computer processes to access a PDO or to cryptographically secure a DO into a PDO. The subsystem can include but is not limited to a User Experience/User Interface (UX/UI), graphical interface or a process which interfaces with an Operating System (OS) Application Program Interfaces (API) to support OS processes necessary to access, open, load, save, close, and the like a file object to make the PDO accessible or loading an unprotected DO and securing the DO with this patent's method.

An aspect of the invention is to provide a high level of data and information security through the use of cryptography and encryption on a per-data object basis, which is efficient and cost effective as used. The use of encryption on a per-data object basis incurs computation costs; however, most organizations do not need to access all documents on a daily basis, therefore the cost to encrypt a DO into a PDO and decrypt the PDO is significantly lower and spread over time over the entire breath of all files. This method eliminates a need to acquire and maintain a Cryptographic Key Management System (CKMS), or key store, while protecting the entirety of the organizations data objects. In organizations requiring high security, such as, but certainly not limited to, large and multi-national corporation, defense, government, intelligence, medical and banking institutions, the cryptographic system can be employed as a secure system inside the boundary of the secure network environment. Other organizations, such as but not limited to, state and local governments, colleges and universities, public and private schools and school systems, medical offices, Small and Medium Business (SMBs) can employ and utilize the system in a closed, semi-accessible network, cloud or other distributed environments. The cryptographic system is indifferent to the existence of a network and can be employed on a computing device, a computing dongle, a smart card, a cloud or hybrid-cloud environment, decentralized network, a traditional network or a hybrid of these types.

The disclosure includes a method, an apparatus, and a system. An embodiment of an apparatus of the disclosure includes a client server computer system for securing a Data Object (DO) as a Protected Data Object (PDO) by encrypting the DO with a symmetric ephemeral cryptographic key (Kᵢ) having precomputable stored components to recalculate Kᵢ during decryption. The system having an at least one communications network or data transport device connecting electronically a server and a client device where at least one of the at least one server, the at least one client device and the network is configured to execute at least one key requesting application configured to request a symmetric ephemeral cryptographic key for cryptographic processing.

And where at least one of the at least one server, the at least one client device and the network is configured to execute an at least one encryption/decryption key engine generating an at least one manifold engine having an at least one facet from a surface mesh generated representing the manifold and calculating an at least one polynomial or quadratic equation and solving a unique surface perpendicular point solution determined through the interaction of the at least one manifold engine and the at least one polynomial or quadratic equation to generate an at least one set of identifiers including an at least one polynomial or quadratic equation coefficient and an initial seed key value to solve for the unique surface perpendicular point on a unique facet of the manifold. The solution of the surface perpendicular point and the at least one set of identifiers is done in conjunction with the at least one manifold and the polynomial or quadratic generates a unique solution for the symmetric ephemeral cryptographic key, which is supplied in response to a request from the client to encrypt the at least one data object to become the at least one protected data object and whereby the symmetric ephemeral cryptographic key is rendered unavailable after the encryption process is completed and the at least one set of identifiers is stored securely to be used to deterministically recompute the symmetric ephemeral cryptographic key on demand for decryption.

Further, in the system, upon encryption of the DO the at least one set of identifiers for symmetric ephemeral cryptographic key are stored securely apart from one another and accessed to deterministically recompute the symmetric ephemeral cryptographic key on demand for decryption. And where the protected data object includes an at least one set of policies stored with the protected data object for decryption. The at least one set of policies can be checked prior to decryption. The at least one set of policies can refer to an element on a block chain.

The at least one set of identifiers can include information to compute subcomponent keys K₁, K₂, and K₃ derived respectively from the at least one polynomial or quadratic equation coefficients, a surface perpendicular point, and a selected facet, and an at least one of the at least one set of identifiers is packaged within the protected data object and at least one set of policies. The at least one of the at least one set of identifiers packaged with the protected data object can be an identifier for the polynomial or quadratic equation.

The at least one polynomial or quadratic equation can be one of a circle, ellipse, parabola, or hyperbola if in two dimensions or one of a sphere, ellipsoid or algebraic polynomial surface if in three dimensions. The at least one polynomial surface can be a sphere having radius and a center point defined by radius value and a set of values for a center. The manifold can be at least one of a sphere, a torus, a Klein bottle, a double torus, a cross surface, a Riemannian manifold, a Kähler manifold, and a Calabi Yau manifold.

The can further include a decryption engine component which deterministically recomputes the symmetric ephemeral cryptographic key on demand for decryption, wherein the decryption engine component is configured to check an at least one data block added to the protected data object during encryption, then recompute the ephemeral, symmetric encryption key using the at least one of the at least one set of identifiers stored within the at least one data block to recompute and provision the transient encryption key and thereby allow the key requesting application to decrypt the protected data object and return the at least one data object. The at least one value to derive the subcomponents is one of an at least one key seed, a unique surface perpendicular point, and an at least one polynomial or quadratic coefficient. The at least one value can be the identifier for the polynomial or quadratic equation coefficient packaged with the protected data object.

The at least one access policies data block can have an associated value on a manifold object lookup table to retrieve the at least one set of identifiers and the at least one encryption/decryption cryptographic engine is configured to reconstitute the transient encryption key from the data block by recalculating the solution for the surface perpendicular point. The at least one access policies data block has an additional value indicating a condition to open the protected data object which must be met prior to decryption.

The at least one additional value can be an at least one policy limitation. The at least one policy limitation includes an at least one an least one Open by date limitation, a ‘Do Not Open Before’ date limitation; a ‘Do Not Open After’ date limitation, an ‘Open By Entities’ limitation; an ‘Open By Users’ limitation; an ‘Open By Groups’ limitation; an ‘Open By Locations’ limitation; an ‘Open By Devices’ limitation; a user limitation, a group of limitations, a policy limitation on locations, a policy limitation on devices, an authorized user identifiers list limitation, and a frequency of access limitation. The at least one access policies data block can have an associated value on a manifold object lookup table to retrieve the at least one set of identifiers and the at least one encryption/decryption cryptographic engine is configured to reconstitute the transient encryption key from the data block by location of the key seed.

The method of an exemplary embodiment of the disclosure includes a method of generating a pseudo-random, symmetric encryption key for use in a computer network system, comprising generating a request for a cryptographic key for encryption from a cryptographic engine of a client subsystem; receiving a request from the client program to a server subsystem or computing device having a key provisioning subsystem configured to render a manifold in Euclidean space and generate surface facets that represent the manifold in a mapping structure; assigning key seeds to the surface facets which are stored as values in a secure table entry; selecting an at least one polynomial or quadratic equation using a randomly selected variable; computing a unique surface based on the selected at least one polynomial or quadratic equation and a set of polynomial or quadratic equation coefficients; solving the polynomial or quadratic equation solutions for the intersection with the manifold at a facet forming a unique surface perpendicular point; generating a combination of key components from values associated with at least one of the key seeds, the unique surface perpendicular point, and the at least one polynomial or quadratic equation coefficients; generating a transient symmetric key by combining the combination of key components; and returning the at least one transient symmetric key to the requesting client program and using the transient symmetric key to encrypt an at least one unprotected data object into an at least one protected data object.

The method further includes recreating the symmetric key to decrypt the protected data object into the unprotected data object upon a further request. A component of the protected data object can provide policies and values for the recreation of the transient symmetric cryptographic key to the client subsystem during decryption. The policies are stored in the protected data object as an encrypted data block and can be decrypted by a server or service performing the step of generating the transient symmetric key.

The policies can be stored in the protected data object as an encrypted data block and include at least one policy limitation. The at least one policy limitation can include an at least one of the following limitations: ‘Open by date’ limitation, a ‘Do Not Open Before’ date limitation; a ‘Do Not Open After’ date limitation, an ‘Open By ‘Entities’ limitation; an ‘Open By Users’ limitation; an ‘Open By Groups’ limitation; an ‘Open By Locations’ limitation; an ‘Open By Devices’ limitation; a user limitation, a group of limitations, a policy limitation on locations, a policy limitation on devices, an authorized user identifiers list limitation, and a frequency of access limitation.

The surface facets can be stored as values in a secure table entry are stored in a manifold table object and the stored values further comprise an at least one identifier, wherein the further method step of decrypting includes the step of associating the at least one identifier with a secure table entry in the manifold table object and yields at least one of the combination of key components for recalculation of the transient symmetric cryptographic key. The manifold generator can generate a manifold of at least one of a sphere, a torus, a Klein bottle, a double torus, a cross surface, a Riemannian manifold, a Kähler manifold, and a Calabi Yau manifold.

The protected data object can be a medical record, a word processing document, government document, a multimedia file,

The method of the invention can further include a method of providing a transient cryptographic key in an encryption security system to perform cryptographic functions including encryption and decryption on a data object in a data network, including accessing the data object with the system; issuing a key request; requesting from a secure manifold server a manifold, a manifold mesh comprised of facets, and an at least one manifold table object representing the manifold and the manifold mesh facets, the manifold having one or more facets thereon and a set of associated identifiers with each facet stored in the manifold table object; generating randomly an initial key seed value; determining an at least one facet on the manifold surface from the at least one manifold table object in combination with the initial key seed value; locating a facet location; generating a polynomial or quadratic equation with an at least one polynomial or quadratic equation coefficient; solving for an at least one surface intersection point whereby the polynomial or quadratic equation is solved at a point on the facet location such that the surface point is calculated at an interface of the at least one polynomial or quadratic equation and the manifold object as a surface intersection point; generating a transient encryption key using at least the combination of the surface intersection point solution in combination with a key seed identifying the at least one facet and the at least one polynomial or quadratic equation coefficients; transmitting the transient encryption key to the cryptographic engine together with an at least one encrypted unique subcomponent key identifier; rendering the key unavailable and irretrievable as a unitary key; and returning the protected data object without an available unitary key on or in the protected data object or stored on the system.

The method further including the issuing of the key request is from a cryptographic engine on a client in the data network. Where requesting the manifold from the secure manifold server further comprising at least the manifold wherein the facet location is located on the facet on the manifold based on the set of identifiers for the determined at least one facet. The method further comprising locating a center of the generated polynomial or quadratic equation based on the at least one polynomial or quadratic equation coefficient.

The method includes transmitting the transient encryption key to the cryptographic engine on a client in the data network requesting the transient symmetric cryptographic key for encrypting the data object using the calculated transient cryptographic key to form a protected data object together with an at least one encrypted unique subcomponent key identifier. The rendering of the key as unavailable and irretrievable as a unitary key is done so that without at least the stored at least one subcomponent key identifier and access to the securely stored manifold object table

The generating of a transient encryption key further includes passing the at least the polynomial or quadratic coefficient, the key seed, and the surface intersection point through a hash function. The surface intersection point can be one of a tangent point or perpendicular point between the surface and the manifold. The surface intersection point can more specifically be a perpendicular point.

The exemplary embodiments of an apparatus of the disclosure further include a system for creating a pseudo-random, symmetric encryption key for use in a computer network system which includes a server or computing device configured to render a manifold in Euclidean space and generating surface facets that represent the manifold in a mapping structure with an at least one random number generator configured to assign key seeds to the surface facets which are stored in a secure table value entry. An at least one input is further configured to select an at least one polynomial or quadratic equation. A surface perpendicular point calculator computing a unique surface perpendicular point value based on the selected at least one polynomial or quadratic equation and the selected at least one polynomial or quadratic equation, the surface point calculator solving the polynomial and/or quadratic equation solutions for the intersection with the unique surface perpendicular point is provided and functions with an at least one transient key generator generating a combination of key components from at least one of the key seeds, the surface perpendicular point, and the at least one polynomial or quadratic equations. An at least one transient symmetric cryptographic key generator which combines the combination of key components into an at least one transient symmetric cryptographic key is calculated. And a data transport transmitting the at least one transient symmetric cryptographic key to a requesting program and which then uses the symmetric key to encrypt an at least one unprotected data object into an at least one protected data object.

Yet another apparatus of an exemplary embodiment of the disclosure provides a cryptographic computer server on an enterprise computer network system for securing a Data Object (DO) as a Protected Data Object (PDO) by encrypting the data object with a symmetric encryption key (Kᵢ). The cryptographic computer server includes a secure storage device configured to protect confidentiality of the information held in a data object with an encryption engine configured to perform a set of instructions so that it derives a symmetric encryption key, generates a set of deterministic values to recreate the symmetric encryption key, encrypts an at least one data object called from the secure storage device to render an at least one protected data object and destroys the symmetric encryption key and stores the set of deterministic values to recreate the symmetric encryption key. A secure cryptographic device configured to add an at least one access policy to the protected data object as an encrypted data block is further provided. A decryption engine configured to perform a set of instructions so that it checks the at least one access policies added to the protected data object to proceed, retrieves the set of deterministic values for symmetric encryption key when prompted by a secure call, derives the encryption key from the deterministic values as a short-lived, transient key, decrypts the at least one protected data object to return the at least one data object and a secure storage device or display configured to store or display the at least one data object after decryption are also provided.

A client subsystem can also be included that allows a user or computing process to access a data object or protected data object in an operating system. The client subsystem can further comprise an at least one client application accessing and calling upon the cryptographic server to encrypt or decrypt the data object. A shimming process between a client program and the operating system function call to integrate the encryption and decryption process into a client application on the client subsystem can also be included.

The encryption engine can have a client side encryption application and a cryptographic server side key provisioning engine, the client side encryption application calling upon the server side key provisioning engine for the provision of the transient cryptographic key and applying the encryption to the data object to create the protected data object using the transient cryptographic key and the server side key provisioning engine deriving the transient cryptographic key and providing the key along with an at least one data block to regenerate the derived transient cryptographic key. The at least one data block to regenerate the derived transient cryptographic key can be packed into the protected data object. The at least one data block can also include an at least one value relating to a set of values representing coefficients for a polynomial or quadratic equation. The encryption engine can also have a client side decryption application which calls upon the cryptographic server side key provisioning engine when decrypting the protected data object.

A further user interface or a user experience can be configured to receive one or more instructions from a user so as to enable a user to directly select the data object or the protected data object from the secure storage device. The client subsystem can also read metadata or a blockchain pointer value or node data, stored as mathematical coefficients, and placed inside the protected data object to assist the decryption engine to recompute the transient cryptographic key. The network can be a data transport which permits information to flow from the client subsystem to the server subsystem and from the server subsystem to the client subsystem.

Another apparatus of an exemplary embodiment of the disclosure includes a transient symmetric encryption key provisioning engine as a portion of a controller or computer or program stored on a computing device, the transient key provisioning engine having a symmetric encryption key requestor a secure transmission data transport to protect the confidentiality of the information held in a data object supplied to and from the key provisioning engine a manifold generator, generating a manifold in Euclidian space having one or more facets. A key seed generator, generating randomly an initial key seed as a value, then using that initial key seed value to determine an at least one facet on the manifold surface from an at least one manifold table object with a surface generator using an at least one polynomial or quadratic equation and configured to solve the at least one polynomial or quadratic equation for a unique surface point representing an intersection on the at least one facet for an at least one polynomial or quadratic coefficient value in combination with the initial key seed value associated with the at least one facet and corresponding at least one manifold table object entry are provided. An encryption key engine is configured to generate a transient symmetric encryption key using at least one of the value from the at least one key seed, the unique surface intersection point, and an at least one polynomial or quadratic coefficient to generate the transient symmetric encryption key and provisioning it to the symmetric encryption key requestor.

The transient symmetric encryption key provisioning engine can further include a user interface coupled to the computing device and receiving user inputs. An at least one access policy data component can also be included, the at least one access policy data component being added to the protected data object provided with the transient symmetric encryption key. The encryption key engine can be further configured to check the at least one access policies added to the protected data object and reconstitute the transient symmetric encryption key using at least one value from the at least one of an at least one key seed, the unique surface intersection point, and the at least one polynomial or quadratic coefficient and return the transient symmetric encryption key to the key requestor.

The encryption component can further include a protected data object packager. The unique surface point representing an intersection on the at least one facet for an at least one polynomial or quadratic coefficient value is a surface perpendicular point, whereby the at least one polynomial or quadratic coefficient value generates a surface having a ray from its origin that is perpendicular to the facet at the unique surface point representing intersection.

The method of the disclosure further provides for a method of providing a cryptographic service via a client server network by operating a client computing device with a client program in an operating environment with a server on a network; shimming an operating layer between the client program and the operating system providing a function call to integrate the encryption and decryption processes into the client program and functioning with the operating environment to facilitate a function call to the cryptographic service from the client program; activating the cryptographic service by the function call; communicating with a remote key generating server as part of the cryptographic server, the remote key generating server having an at least one remote transient key calculating engine and an at least one manifold generator engine; determining with the remote key generating server with an at least one calculated subcomponent key for encryption or an at least one calculated subcomponent key for decryption; using said at least one subcomponent key to locate a unique point on a facet of a manifold generated by the manifold generator; storing the at least one subcomponent key as secure data; using the unique point, the manifold to generate a transient encryption key; and transmitting the at least one transient encryption key to an at least one encryption/decryption engine residing on the client that encrypts a data object with the transient encryption key and destroys the key, and returns an encrypted protected data object or decrypts a protected data object by accessing the at least one subcomponent key, reconstituting the transient encryption key and then decrypts the protected data object to render the data object, the encryption/decryption engine returning a protected data object or data object based on the call from the client program.

The at least one subcomponent key can be an at least three component keys, the at least three component keys can further comprise a first of an at least three component keys indicating the manifold shape, a second of an at least three component keys solving for a specific perpendicular point of intersection of a polynomial equation on the manifold determined with a set of polynomial equation coefficients, and a third of an at least three component keys selecting a pseudo random number defining a facet of the manifold.

The method can also further comprise providing a user or computing process access to the data object or the protected data obj ect and receiving one or more instructions at the client from a user interface enabling a user to directly select a data object or protected data object from file storage. The method can include receiving one or more instructions at the client from a user interface which triggers the shimming process. The shimming process can further comprise redirecting a call initiated by the client subsystem to encrypt/decrypt the data object to an at least one API server.

The redirecting of the call to an API server can also include redirecting at least one of a write command, an update command, a create command, and a delete command. The redirecting of the client program commands to the API server can further include redirecting a read file command, loading a protected data object into memory and passing control to the cryptographic server to request a transient cryptographic key and returning through the output of the cryptographic server the transient cryptographic key to the encryption/decryption engine on the client subsystem.

The transient encryption key can be sent through a secure connection with the client subsystem. The secure connection can be an encrypted communications channel or tunnel. The encrypted communications channel or tunnel is a Secure Socket Layer (SSL). The method can further include sending the API server a write command, the shimming process interrupting the operating systems write command and transmitting a separate call to load the data object into memory on the client subsystem and passing control to the cryptographic server to return the transient cryptographic key to the encryption/decryption engine on the client and the encryption/decryption engine using the transient key to encrypt the data object into a protected data object.

The method further comprising redirecting and sending the API server a read command, the shimming process interrupting the client program from opening the protected data object from file storage, and including further interrogating the protected data object and locating an at least one block of data identifying the at least one subcomponent key for reconstituting the transient encryption key for decryption. The method additionally including moving the protected data object into storage on a client, opening the at least one block of data identifying the subcomponent key, retrieving the subcomponent key data, reconstituting the transient encryption key, recalculating using said at least one subcomponent key to locate a unique point on the facet of a manifold generated by the manifold generator and returning the reconstituted transient encryption key to the at least one encryption/decryption engine residing on the client.

The apparatus of the disclosure further includes a system of providing a cryptographic service via a client server network, having a computing device configured to execute a client program in an operating environment and having a shimming layer operating between the client program and the operating system providing a function call to integrate an encryption and a decryption processes into the client program and functioning with the operating system to facilitate the function call to a server. With a server having a cryptographic server subsystem configured to be activated by the function call, having or communicating with a remote key generating server, the remote key generating server having an at least one remote transient key calculating engine and an at least one manifold generator engine, wherein the remote key generating server determines an at least one calculated subcomponent key for encryption or is provided an at least one calculated subcomponent key in for decryption and using said at least one subcomponent key locates a unique point on a manifold generated by the manifold generator, stores the at least one subcomponent key as secure data and using this unique point calculates/returns a unique transient encryption key. And providing an at least one encryption/decryption engine that encrypts a data object with the transient encryption key and destroys the key, and returns an encrypted protected data object or decrypts a protected data object by accessing the at least one subcomponent key, reconstituting the transient key and then decrypts a protected data object to render the data object, the encryption/decryption engine returning a protected data object or data object based on the call from the client program.

The at least one subcomponent key can be an at least three component keys, the at least three component keys further comprising a first of an at least three component keys indicating the manifold shape, a second of an at least three component keys solving for a specific perpendicular point of intersection of a polynomial equation on the manifold determined with a set of polynomial equation coefficients, and a third of an at least three component keys selecting a pseudo random number defining a facet of the manifold used in conjunction with the second of the at least three component keys. The system can further include a client server subsystem configured to interact with the client program operating in an operating environment on a computing device as part of the client program.

The at least one encryption engine can also be at least one part of the client server subsystem. The client subsystem can also provide a user or computing process access to the data object or the protected data object. The client subsystem further receives one or more instructions from said user interface to enable a user to directly select a data object or protected data object from file storage.

The shim layer can be part of a client program running in an operating system on a computing device and coupled to the network and an at least one client call triggers the shim layer process and a call is sent via network to a manifold server to process the encryption. The system can further include an Application Program Interface (API) server, wherein the client server subsystem is configured to use the shim layer to intercept and redirect an at least one API server call from the operating system to the client server subsystem via the network. The at least one API call intercepted and redirected includes an at least one of a write command, a read command, an update command, a create command, and a delete command.

The encryption/decryption engine can be on the client subsystem. The client can also send the API server a read file command and the shim interrupts the operating systems read file call and executes a separate call to load the protected data object into memory on the client subsystem and passes control to the cryptographic server to return the transient cryptographic key to the encryption/decryption engine on the client subsystem upon receipt of the transient cryptographic key. The return of the transient encryption key can be through a secure connection.

The secure connection can be an encrypted communications channel or tunnel. The encrypted communications channel or tunnel can be more specifically a secure sockets layer. The client can sends the API server a write command, where the shim interrupts the operating systems write command and executes a separate call to load the data object into memory and passes control to the cryptographic server to return the transient cryptographic key to the encryption/decryption engine on the client and the encryption/decryption engine uses the transient key to encrypt the data object into a protected data object.

Yet another apparatus of an exemplary embodiment of the disclosure is a cryptographic server configured to operate an encryption key provisioning sever subsystem as to provision an encryption key for encrypting and decrypting a data object, having an at least one key establishment protocol server, an at least one manifold server, an at least one polynomial or quadratic equation or surface server, an at least one cryptographic key generator server, an at least one key access management policies server creating one or more embeddable key access management policies; and an at least one encryption engine applying an encryption protocol utilizing a symmetric key, wherein the encryption engine requests key provisioning for encrypting or decrypting the data object with the encryption protocol with a transient key generated by the at least one transient cryptographic key generator and accesses the one or more key access management policies to store key subcomponent identifiers in the case of encryption or to interrogate/confirm the one or more key subcomponent identifiers in the case of decryption before encryption or decryption of the data object.

The at least one manifold server can further include an at least one manifold object feature input, an at least one manifold seed object pseudo random number generator, an at least one algebraic manifold generator, an at least one facet surface mesh generator, an at least one manifold object, and at least one manifold table object. The at least one manifold object feature input can also include at least one of the following manifold variables: a manifold orientation, a manifold dimensionality, and a maximum average dimensional aspect of a surface face.

The system automatically and randomly selects the manifold variables. The cryptographic server system can further include a user interface, where an at least one user input from the user interface can select the manifold variables. The at least one manifold seed object pseudo random number generator can also generates a manifold seed object. The at least one manifold seed object pseudo random number generator can additionally include a pseudo random number generator and creates an at least one random number output with the pseudo random number generator and performs an exclusive-oring function on the randomly generated number from the pseudo random number generator to create the manifold seed object.

The manifold seed object can be input into the algebraic manifold generator to generate the manifold in three-dimensional Euclidean space. The facet surface mesh generator can also generate surface facets in a mesh over the manifold. One or more elements of the manifold object can be derived from an output of the at least one algebraic manifold object generator and the facet surface mesh generator which are saved into the manifold table object as a database that stores the data required for the components to compute a surface point solution.

The cryptographic server system can additionally include an at least one element of the manifold object, whereby the at least one element of the manifold object is derived from at least one of an output of the manifold object generator and the facet surface mesh generator, the at least one element being saved into the manifold table object as a database that stores the data required to compute a surface point solution. The manifold seed object can also be used as the seed for the calculations performed with the at least one algebraic manifold object generator and the surface facets produced by the facet surface mesh generator.

The cryptographic server system can further comprise a key seed pseudo-random number generating component, wherein the key seed pseudo-random number generating component generates an at least one key seed for each surface facet in the manifold table object. The key seed pseudo-random number generating component can also include at least one of the following: an at least one key seed feature input, an at least one key seed generator, an at least one key seed to facet mapper, and an at least one process communication bus. The key seed pseudo-random number generating component generates one or more unique key seeds for each surface facet in the manifold table object

The encryption engine can be located on a client subsystem and requests key provisioning when a call for the transient key is sent by a client application and engages the transient cryptographic key generator on a server connected by a data transport and communicates the call from the client to the server subsystem containing the at least one transient cryptographic key generator. Further, upon receipt of the call from the client, the call can be parsed by the transient cryptographic key generator to verify the key request data.

The cryptographic server can also include an at least one request parser receiver within the transient cryptographic key generator, whereby the request parser receiver is configured to determine if an at least one set of data blocks are populated in the request or the whether the at least one set of data blocks are null. The at least one set of data blocks can be a data block representing an at least one set of polynomial equation coefficients and a data bloc representing a preselected policy for the data.

Where the data block for the polynomial equation coefficients are null, then a new key request for encryption can be made and a facet selection process can be commenced by the at least one transient cryptographic key generator. The facet selection process can engage a pseudo random number generator or request input for same and thereby randomly selects a surface facet identifier and its corresponding facet properties and associated key seed from the manifold table object and loads the properties and key seed into an at least one random access memory.

The cryptographic server system can additionally include a surface perpendicular point calculator having an at least one point selector, where in conjunction with the selected surface facet and its corresponding facet properties the at least one point selector randomly selects a point on the identified facet and the surface perpendicular point calculator determines a unique surface perpendicular point solution for the given manifold, facet, and polynomial equation values.

The at least one transient cryptographic key generator can further comprise a transient key subcomponent key engine, whereby an at least one subcomponent key is generated by the transient key subcomponent key engine to form the transient cryptographic key. The at least one subcomponent key can also be three subcomponent keys, the first of the three keys is generated utilizing polynomial equation coefficients, the second of the at least three keys is generated using the at least one surface perpendicular point value, and the third of the at least three subcomponent keys is generated using the key seed value.

The cryptographic server system of claim, where if the at least one set of polynomial equation coefficients are populated, the request can be determined to be a decryption request and the transient cryptographic key generator retrieves the data populating the at least one set of polynomial equation coefficients from the policy data and passes the data to a polynomial equation engine.

The cryptographic server system can include a surface perpendicular point calculating engine whereby the surface perpendicular point calculating engine is configured to receive the at least one polynomial coefficient and the surface facet properties and regenerate the surface perpendicular point. A user interface can also be provided coupled to the client server subsystem whereby random inputs can be provided by the user through the user interface. The random user inputs can further include at least one of a mouse movement, a keyboard keystroke, a visual input, and a sound input. The random inputs generate the primitive seed which is entered into a key seed generating process.

The apparatus of the disclosure include an additional exemplary embodiment as a circuit board having an at least one ASIC thereon and having a communications bus, wherein the ASIC is configured to communicate with and receive instructions from an operating system and provide a key provisioning system to a cryptographic system communicating with the operating system. The circuit board including means for transmitting a data object for encryption or a protected data object for decryption to the circuit board through the communications bus with an encryption/decryption engine and a processing circuit generating a transient cryptographic key utilizing a three-dimensional manifold providing a manifold and an at least one manifold table securely stored and calculating an at least one transient key sub-component and thereby further calculating a transient cryptographic key and communicating these values and the calculated transient encryption key to the encryption/decryption engine, wherein the processing circuit is configured to wherein the circuit board ASIC is configured to communicate with the operating system via an encryption call through the transmission means to provide the transient cryptographic key to the encryption engine to encrypt the data object or via a decryption call through the transmission means for a previously encrypted protected data object and calculate with the three-dimensional manifold engine a transient encryption key and key sub-components for the encryption/decryption engine to process the data object into an encrypted protected data object or to decrypt the previously encrypted protected data object using the transient key and key sub-components, then rendering the transient key unavailable.

The cryptographic system can be contained on the ASIC chip. The encryption/decryption engine can also be located on the ASIC chip. The manifold table can further retain information related to the output of the manifold engine. The manifold engine can be further configured to process a request and select a specific three dimensional manifold from several manifolds stored within the manifold engine and thereby an at least one manifold table object representing the manifold surface, the manifold surface having one or more facets thereon.

The apparatus can further include a random number generator generating randomly an initial key seed as a value then using that initial key seed value to determine an at least one facet on the manifold surface from the at least one manifold table object. The encryption/decryption engine can also use the requested specific three dimensional manifold and the initial key seed and the initial key seed value to locate a facet location on the three dimensional manifold;

The transient cryptographic key generator can further generate a polynomial or quadratic equation with an at least one polynomial or quadratic equation coefficient. The encryption/decryption engine can also locate a center of the generated polynomial or quadratic equation based on the at least one polynomial or quadratic equation coefficient. The encryption/decryption engine can further configured to solve for an at least one surface intersection point whereby the at least one polynomial or quadratic equation is solved at a point on the at least one/selected facet location such that the at least one surface point is calculated at an interface of the at least one polynomial or quadratic equation and the manifold object at a defined solution set for the surface intersection point.

The encryption/decryption engine can also use the surface intersection point solution in combination with the key seed and the polynomial quadratic coefficients to generate a transient encryption key. The encryption/decryption engine can also encrypt the data object into a protected data object or decrypts the previously encrypted protected data object into a data object using the generated transient encryption key. The encryption/decryption engine can further store at least one of the polynomial or quadratic coefficient, the key seed, and the surface intersection point as a value in a data block with the encrypted data object.

The encryption/decryption engine can also render the key unavailable and irretrievable as a unitary key without the data block and returns the protected data object without a full key on or in the protected data object. The encryption/decryption engine as part of the encryption can pass the at least one polynomial or quadratic coefficient, the key seed, and the surface intersection point through a hash function before storage. The surface intersection point can be one of a tangent point or perpendicular point between the surface and the manifold. The surface intersection point can also be a perpendicular point relative to the manifold and the polynomial quadratic equation calculated surface.

A still further exemplary embodiment of a method of the disclosure includes a method of encryption within a battlespace management system (BMS) including requesting encryption of a data object; requesting and selecting a three dimensional manifold and thereby an at least one manifold table object representing the manifold surface, the manifold surface having one or more facets thereon; generating randomly an initial key seed as a value then using that initial key seed value to determine an at least one facet on the manifold surface from the at least one manifold table object; locating a facet location on the three dimensional manifold based on the initial at least one facet; generating a polynomial or quadratic equation with an at least one polynomial or quadratic equation coefficient(s).

A further exemplary embodiment of the method of the disclosure includes a computer-implemented method for provisioning a transient cryptographic key for securing a data object as an encrypted, protected data object or decrypting a protected data object in a distributed file system/client server network. The method comprising requesting a transient cryptographic key from a client program; determining if the transient cryptographic key request is for encryption or decryption by analyzing a data block retrieved from the encrypted set of data blocks packaged with the request; proceeding with creation of a transient cryptographic key if the request is for an encryption of a data object including the steps of: communicating with a manifold object subsystem; accessing a three dimensional manifold having facets in the manifold object subsystem; selecting an at least one polynomial or quadratic equation having an at least one set of polynomial or quadratic coefficients; generating an at least one random key seed to generate a unique surface intersection point between the manifold and the at least one polynomial or quadratic equation; and using the value at that point to save set of identifiers as subcomponent keys in a manifold object table, then generating the transient cryptographic key and returning the generated cryptographic key to the requestor along with an at least one identifier; then returning the cryptographic key for encryption with the at least one identifier, the client program packing the at least one identifier with the encryption on the protected data object; and proceeding with provision of the transient cryptographic key if the request is for a decryption of a data object including the steps of: communicating with the manifold object subsystem; receiving an at least one identifier from the protected data object as part of the step of requesting the transient cryptographic key and providing the at least one identifier to the manifold object system; using the at least one identifier to access the manifold object table associated with the at least one identifier, and return values for the manifold and facets; using the at least one identifier to regenerate the at least one polynomial or quadratic equation having an at least one set of polynomial or quadratic coefficients; then regenerating the unique surface intersection point between the manifold and the at least one polynomial or quadratic equation; and proceeding with recreation of the transient cryptographic key for the request for decryption of a data object.

Yet a further exemplary embodiment of the apparatus of the disclosure includes a key provisioning computing device on a computer network providing a cryptographic key for encryption, comprising a computing device configured to receive a request for the key from a client computing device and further configured to generate a transient key by determining a set of values for a polynomial or quadratic equation, calculating a manifold with an at least one facet, selecting a point on the at least one facet, solving the polynomial or quadratic equation for an intersection point with the manifold and the point on the at least one facet and generating a key based on this solution together with an at least one subcomponent identifier, wherein the key is returned to the client computing device along with the least one subcomponent identifier.

Another exemplary embodiment of the apparatus of the disclosure includes a key provisioning computing device on a computer network providing a cryptographic key for decryption, having a computing device configured to receive a request for the key from a client computing device and further configured to receive a subcomponent key identifier with the request, regenerate a transient key by recalculating a set of values for a polynomial or quadratic equation, a manifold with an at least one facet, a selected point on the at least one facet, and solving the polynomial or quadratic equation for an intersection point with the manifold and the point on the at least one facet and thereby regenerating the key based on the recalculated solution from the at least one subcomponent identifier, wherein the transient key is returned to the client computing device.

Still a further exemplary embodiment of the apparatus of the disclosure provides an electronic device for securing a Data Object (DO) as a Protected Data Object (PDO) by encrypting the DO with a symmetric ephemeral cryptographic key (Kᵢ), the electronic device comprising interface circuitry, machine-readable instructions and processor circuitry to execute the machine-readable instructions to receive a request for a symmetric ephemeral cryptographic key for cryptographic processing and generate at least one set of identifiers including an at least one polynomial or quadratic equation coefficient and an initial seed key value to solve for a unique surface perpendicular point on a unique facet of the manifold based on a unique surface perpendicular point solution determined through an interaction of at least one manifold engine and the at least one polynomial or quadratic equation, wherein the solution of the surface perpendicular point and the at least one set of identifiers in conjunction with the at least one manifold and the polynomial or quadratic equation generates a unique solution for the symmetric ephemeral cryptographic key. Further, the electronic device provides the symmetric ephemeral cryptographic key to the requestor to encrypt the at least one data object to become the at least one protected data object.

The disclosure also includes a non-transitory machine-readable storage medium including program code, when executed, to cause a machine to perform the methods of the invention disclosed herein. As well as a computer program including program code, when executed, to cause a machine to perform the method of one or more of the disclosed embodiments and/or one or more of the disclosed claims.

Moreover, the above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

Embodiments of the invention are explained in greater detail by way of the drawings, where the similar reference numerals refer to similar features.

FIG. 1 is a schematic showing the overall architecture of the cryptographic system according to an exemplary embodiment.

FIG. 2 is a view that illustrates the data transport, client process and server service connections according to the embodiment of FIG. 1.

FIG. 3 is a view which illustrates data containers, which are the unprotected and protected data object according to the embodiment of FIG. 1.

FIG. 4 is a view which illustrates the PDO access policy integrated into a blockchain smart contract with Non-Fungible Token (NFT).

FIG. 5 is a view showing the components of an exemplary embodiment of the client subsystem.

FIG. 6 is a process flow chart view showing a client shimming process.

FIG. 7 is a view showing an exemplary embodiment of the client encryption component.

FIG. 8 is a process flow chart view showing an exemplary embodiment of the client encryption process.

FIG. 9 is a view showing an exemplary embodiment of the client decryption component.

FIG. 10 is a process flow chart showing an exemplary embodiment of the client decryption process.

FIG. 11 is a view showing the components of an exemplary embodiment of the server subsystem.

FIG. 12 is a view showing an exemplary embodiment of the Kᵢ computing component according to the embodiment of FIG. 1.

FIG. 13 is a process flow chart showing an exemplary embodiment of the Kᵢ computing process when PQC and C_{Policy} are null according to the embodiment of FIG. 12.

FIG. 14 is a process flow chart showing an exemplary embodiment of the Kᵢ computing process for PQC and C_{Policy} is not null according to the embodiment of FIG. 12.

FIG. 15 is a 3-D graphical illustration showing an exemplary embodiment of a PQ-Equation and PQC mapped to the manifold and the facet.

FIG. 16 is a view showing an exemplary embodiment of the manifold object generator component.

FIG. 17 is a process flow chart showing an exemplary embodiment of the manifold object generator process of FIG. 16.

FIG. 18 is a view showing an exemplary embodiment of the KS pseudo-random number generating component.

FIG. 19 is a process flow chart for an exemplary embodiment of the KS pseudo-random number generating process of FIG. 18.

FIG. 20 shows a view of an exemplary embodiment of the instant invention as a component of an enterprise data network system.

FIG. 21 shows a view of a further exemplary embodiment of the instant invention as a key provisioning service for encryption to secure documents in a cloud storage server.

FIG. 22 shows a view of an exemplary embodiment of the instant invention as a key provisioning service for a cryptographic system used as a third party application for submitting secure, encrypted bids for contracts with access date restrictions.

### DETAILED DESCRIPTION OF THE EXEMPLARY EMBODIMENTS OF THE INSTANT INVENTION

Exemplary embodiments according to the present invention will now be described with reference to the accompanying drawings. The references and representations of elements and embodiments of the invention described throughout and examples provided are non-limiting, exemplary embodiments and examples and to be construed as such.

The importance of data in everyday life is pervasive, in every action taken in the modern economy, data and data elements are generated, consumed, traded, and tracked. Data plays a significant role in all the sectors of the economy and even in our personal lives. Data issues touch a wide range of personal aspects in our lives and are central in a wide range of things, like tracking our health to monitoring our safety to playing a key part in cybercrimes. All of these things show that so called “raw data” or “unprotected data” is increasingly critical in every area of life and therefore more valuable and needing defense when exposed, transmitted, or used.

Raw data can contain sensitive details that can cause harm in the hands of cybercriminals and other bad actors to persons and companies alike.

The danger in allowing data to exist without protection is myriad. In the most direct and obvious, criminals can gather pieces of data and use it to identify personally identifiable information (PII) or they may want to blackmail a company by threatening to release private data or hold them hostage via ransomware attacks. Bad actors can sell the data to brokers and expose anything from individual private information to the intellectual property of a company, and in some instances, even non-bad actors can overreach in data collection. It is therefore important to protect the raw data.

Encryption is key to the art of data protection. Encryption methodologies has been in society since 600 BC, protecting some of the most critical information, from military planning to crop results. Encryption is applied to secure files, in file level encryption, or data, in object level encryption, or through other mechanisms and in other categories. At its most basic, encryption is a method by which data is converted into a code that hides the data's true meaning and content. Though the concept might seem easy to grasp, in reality, the process of encryption is, in fact, a rather complex one to execute. The complexity within the elements of any encryption adds to the level of protection. Moreover, the less complex the encryption methodology the more likely it is to be overcome.

Today, encryption is conducted by and on a wide variety of devices and networks we access regularly to protect our communication and applied to a wide range of items. This encryption is performed in fractions of a second by modern hardware and software without notice in typical transactions. The degree of this encryption and the strength of the protection is varied by the need for speed in communication and ease of use as well as the limitations of computational power.

In an effort to provide a more robust encryption methodology and improve the ease of use of encryption suitable for use in a wide variety of environments the instant invention provides a unique methodology utilizing, in at least part but certainly not being limited to, an at least one key establishment protocol, an at least one n-dimensional manifold, an at least one polynomial or quadratic equation or surface, an at least one cryptographic key generator, one or more embedded key access management policies and an at least one encryption schema.

The cryptographic system improves information security by implementing a unique key establishment protocol and process to compute a symmetric Transient Cryptographic Key for a maximum duration of encrypting or decrypting a data object, then destroying the key or otherwise requiring no storage method to retain the key. The invention locally stores coefficient properties and access policy data blocks within the protected data object, which is used to generate the Transient Cryptographic Key (Kᵢ) without the need to store Kᵢ. The key establishment protocol defines the rules, syntax, and semantics of the data blocks transmitted between the Client Subsystem and server key generating service, used to compute and recompute the symmetric key. The Policy Actions process provides a method to apply access policies to the data object, which informs the Server Subsystem under what conditions the Transient Cryptographic Key can be provided to the requesting client.

The instant invention is unique in that it wraps multiple layers of mathematical complexity to/into the encryption methodology as well as multiple discrete key components transmitted in part as separate components providing a more robust solution without decreasing the entropy and randomization within the system, as the number of permutations for unique solutions remains extraordinarily high with extremely low chance of repetition. This methodology can be incorporated as part of an encryption engine that is integrated or embedded into devices at the hardware, operating system and application layer as a device application, cloud-based applications, blockchain applications, physical storage devices, operating system kernels, and the like.

The instant invention utilizes symmetric key encryption methods. In the exemplary embodiment shown, symmetric cryptographic is utilized as a non-limiting example for this exemplary embodiment. The symmetric Transient Cryptographic Key (Kᵢ) in each embodiment is computed from component keys (K₁ . . . Kₙ) and are combined to form Kᵢ, using, but not certainly not limited to, at least one the following or a combination of the methods of equations 1 and/or 2:
Concatenating two or more keys:

Kᵢ=K₁∥K₂∥K₃∥ . . . ∥Kₙ (1)
Exclusive-Oring one or more symmetric keys and other items of data:

Kᵢ=K₁⊕K₂⊕K₃⊕ . . . ⊕Kₙ⊕D₁⊕ . . . ⊕Dₙ (2)

Component key (K₁) is mathematically computed through a secure hash algorithm, Expression 4, using a concatenation of other data, defined in this embodiment as PQC, illustrated in Expression (3).

PQC=i∥j∥k∥r∥ . . . ∥Dₙ (3)

K₁=PQC→f(hash) (4)

Component key (K₂) is mathematically computed through a secure hash algorithm, illustrated in Expression 6, using a concatenation of other data, defined in this embodiment as SPP, illustrated in Expression (5) and defined herein below.

SPP=m∥n∥o∥ . . . ∥Dₙ (5)

K₂=SPP→f(hash) (6)

The Key Seed (KS) concatenates a PRNG, Manual Object Features Input (MOFI), Manual Random Number Generator (MRNG) and other data, as defined in this exemplary embodiment and illustrated in Expression (7).

KS=f(PRNG)∥MOFI∥MRNG∥ . . . ∥Dₙ (7)

Component key (K₃) is mathematically computed by passing the KS through a secure hash algorithm, in this exemplary embodiment illustrated in Expression (8).

K₃=f(hash(KS)) (8)

In particular, as represented by, but not limited to, Expressions (9), (10), and (11), a manifold is defined as topological space that locally resembles Euclidean space, taking a geometric object [symbol] and fitting into [symbol] , n>k.
M can be, but is not limited to, for instance a sphere

0=(x²+y²+z²−1) (z>0 and z<0) (9)
M can also, for example, be but is not limited to being represented as a torus

a²=(c−√(x²+y²))²+z² (10)

x=(c+a cos v)cosu

y=(c+a cos v)sin u

z=a sin v
M can additionally be, but is not limited to being represented as a Klein Bottle

0=(x²+y²+z²+2y−1)[(x²+y²+z²−2y−1)²−8z²]+16xz(x²+y²+z²−2y−1) (11)

x=cos u [cos(u/2)(√2+cos v)+sin(u/2) sin v cos v]

y=sin u [cos(u/2)(√2+cos v)+sin(u/2) sin v cos v]

z=−sin(u/2)(√2+cos v)+cos(u/2) sin v cos v]

In each embodiment, the manifold is processed into the projective Euclidean space. Finite element analysis and surface mesh generation algorithms transform the [symbol] geometric manifold M into surface facets, as illustrated in a non-limiting example by Expression (12).

(x₁, y₁, z₁)→(x₂, y₂, z₂)→ . . . →(xₙ, yₙ, zₙ) (12)

A polynomial is defined as an expression comprising indeterminates and coefficients, that involves the operations of addition, subtraction, multiplication, and non-negative integer exponentiation of variables. The polynomial is processed into the projective Euclidean space, illustrated as a non-limiting example in Expression (13).

aₙxⁿ+aₙ₋₁xⁿ⁻¹+ . . . +a₂x²+a₁x+a₀ (13)

A quadratic equation is an algebraic expression of the second degree in x. In each embodiment,

the quadratic equation can represent a circle, ellipse, parabola or hyperbola in two variables. The quadratic is processed into the projective Euclidean space, illustrated in a non-limiting example as Expression (14).

ax²+bx+c=0 (14)

A quadratic surface is an algebraic expression of the third degree. In each embodiment, the quadratic surface can represent a sphere, ellipsoid, or other algebraic topology in three variables. The quadratic surface is processed into the projective Euclidean space, illustrated in a non-limiting example as Expression (15).

(x²+y²+z²−1)=0 (z>0and z<0) (15)

In an exemplary embodiment, a surface manifold, M, is processed into a surface mesh and decomposed into facets, as represented by Expression (12). These facets are stored in a database and are selected randomly to participate in the generation of key (Kᵢ) for an encryption request. For decryption, Kᵢ is computed by processing the polynomial or quadratic equation or surface into the Euclidean space, Expressions (14) or (15), computing a point or set of points on M, where the polynomial or quadratic equation or surface interact with M. In this embodiment, a perpendicular interaction at the intersection between M and the polynomial or quadratic equation or surface is used as a valid point or set of solutions; however, other interactions, such as but not limited to a tangent can be used to identify a unique interaction with M.

Although a set of perpendicular points exist within the solution set, one point is calculated and uniquely represents the Surface Perpendicular Point (SPP). There are several ways to solve for SPP, one method uses vector math. This embodiment, Kᵢ cannot be computed without bringing together the Protected Data Objects (PDO) Polynomial/Quadratic Equation Coefficients (PQC) into the model manifold M to compute the SPP as represented in Expression (2).

In this embodiment, standard approved encryption algorithms and computing libraries are used to transform a Plaintext (P) into Ciphertext (C) and from ciphertext back into plaintext. It is to be understood by those of ordinary skill in the art that as new encryption algorithms and computing libraries are developed, these would be embraced and incorporated in the instant invention. The encryption and decryption processes of the exemplary embodiment used as a non-limiting example of the instant invention are represented by Expressions (16) and (17).
Plaintext to Ciphertext (P→C)

C=E(Kᵢ, P) (16)
Ciphertext to Plaintext (C→P)

P=D(Kᵢ, C) (17)

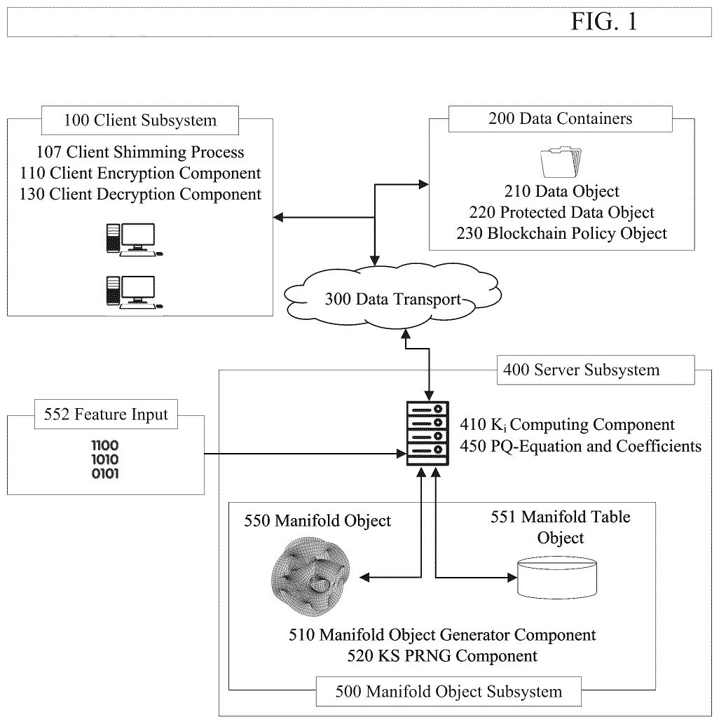

FIG. 1 is a schematic showing the overall architecture of the cryptographic system according to an exemplary embodiment. The schematic shows the cryptographic system with a Client Subsystem 100, Data Containers 200, a Data Transport Link 300, the Server Subsystem 400, and the Manifold Object Subsystem 500. As would be understood by one of ordinary skill in the art, the location of the elements can be varied to suit the limitations of a given application or system and design parameters specific to the deployment of the invention.

In the exemplary embodiment shown, the Client Subsystem 100 can include, but is not exclusive of, a software application residing on a server or computing device, an embedded computing device or system, or a special purpose hardware computing solution; accessible by a human or machine to interface with the data objects and the servers, running on a physical or virtual computer, a mobile device, cloud-based computer, web-based service, Internet of Things (IoT) device, and the like. Client Subsystem 100 possesses the Client Encryption Component 110 and the Client Decryption Component 130. In this embodiment, Client Subsystem 100 is shown separate from Server Subsystem 400 and Manifold Object Subsystem 500; however, these subsystems can reside on a single computing device or can reside on separate computing devices as shown.

In the exemplary embodiment shown, Data Container 200 includes digital information or data objects, such as data files, data collections, data documents in any format; unencrypted, encrypted, partially encrypted, encoded or not encoded. The stored location for a Data Object 210, a Protected Data Object 220 and the Blockchain Policy Object 230 can include, but is not limited to, a hard drive, a portable storage drive, network file system, cloud-based storage, embedded device data, InterPlanetary File System (IPFS), centralized and decentralized storage systems, and the blockchain. The Blockchain Policy Object 230, for instance, can refer to policies for a smart document with a pointer to locations on the blockchain or, as discussed above, provide enhanced security in storing and verifying the PQC data with a similar pointer to a node location on the blockchain.

In the exemplary embodiment shown, Data Transport 300 provides a method and any accompanying hardware, to communicate between the Client Subsystem 100 and the Server Subsystem 400 and is indifferent to the location and retrieval method of the Data Container 200 and is indifferent to the methods of key establishment protocol, symmetric key encryption standard, or secure standard for transmission to/from the Data Transport 300. Data Transport 300 can be, but is not exclusive of, a computer network, a hardware device computing port, such as a Universal Serial Bus (USB), various wired and wireless protocols, such as Wi-Fi and Bluetooth, the World Wide Web (WWW), and the like and accompanying network and transmission hardware in the case of both terrestrial and wireless networks.

In the exemplary embodiment shown, Server Subsystem 400 provides a response to the Client request, which can include, but is not limited to, the key (Kᵢ) and PQC and similar values as described further herein below. The server is hardware or a software-based application which runs on, but is not exclusive to a computer, server-computer, a cloud-based virtualized computer, a mobile device, an IoT device, an embedded device, a portable computing dongle, and/or the like. Server Subsystem 400 is responsible for at least accepting the Client request, processing the request and computing the cryptographic key. Further, the server sub-system can maintain additional software such as but not limited to an encryption/decryption subsystem, data organizing applications and software, communications architecture and software, file storage and the like without departing from the instant invention. Based on the Client request, if for a new key, Server Subsystem 400 will create a new Transient Cryptographic Key and provide the key and PQC back to the Client. If the Client request is to recompute the key, Server Subsystem 400 will compute the key based on the provided PQC, validate if the access policies have been met, then return a response to the Client. If the policies have been met, then Server Subsystem 400 will provide the key to the requesting Client. If the policies have not been met, Server Subsystem 400 will destroy the key and return an error to the requesting Client.

In the exemplary embodiment shown, The Manifold Object Subsystem 500 is a software application which includes the 3-dimensional Manifold (M), the Manifold Object Table (MOT) and other processes to enable the generation and recomputing of the deterministic Transient Cryptographic Key (Kᵢ).

In the exemplary embodiment of FIG. 1, Manifold Object Subsystem 500 is managed by Server Subsystem 400 to allow the Manifold Object Generator Component 510 and KS PRNG Component 520 to compute the Manifold Object 550 and populate the Manifold Object Table 551 as shown. Again, the specific management of the components can be tasked to other subsystems, but the importance is the calculation of the Manifold Object 550 and its primary intersects as explained herein to provide for a robust encryption element. The Manifold Object Generator Component 510 by use of Server Subsystem 400 permits Feature Inputs 552 to generate the manifold object. Manifold Feature Inputs 552 can be derived from a random process or a manual process.

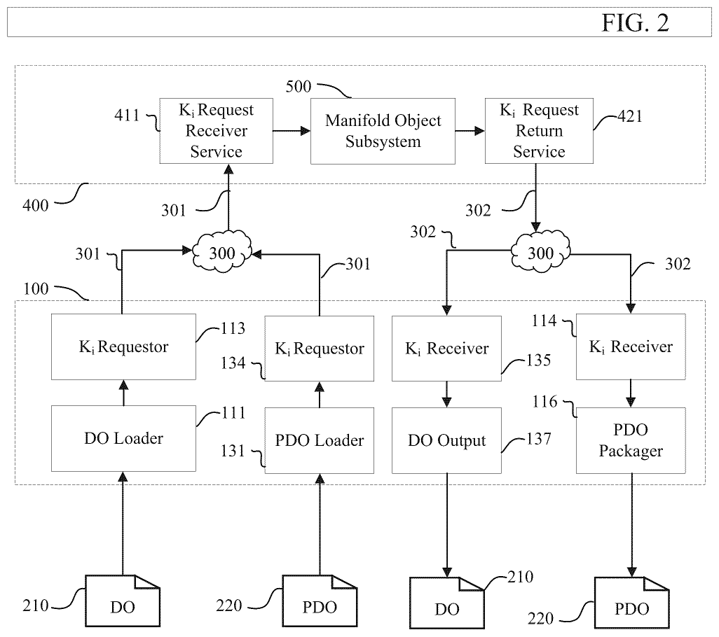

FIG. 2 is a view that illustrates the data transport, client process and server service connections according to the embodiment of FIG. 1. In the exemplary embodiment, for the flow of information between the Client Subsystem 100 to the Server Subsystem 400 across the Data Transport 300.

The general process flow for protecting a DO 210 begins with the Client Subsystem 100 at the DO Loader 111 which loads the unencrypted data object to be protected. A request is made by the Kᵢ Requestor 113 process to the Server Subsystem 400 at the Kᵢ Request Receiver 411 service, across the Data Transport 300, where 301 identifies the connections between the Client Subsystem and the Server Subsystem. The Server Subsystem 400 processes the request, communicating internally with the Manifold Object Subsystem 500. When the key has been computed the Server Subsystem 400, Kᵢ Request Return 421 service replies to the Client Subsystem 100 at the Kᵢ Receiver 114 entry point. The Client Subsystem 100 PDO Packager process 116 saves the PDO 220 to file storage as a protected data object.

The general process flow for decrypting/accessing a PDO 220 begins with the Client Subsystem 100 at the PDO Loader 131, which loads the protected data object. A request is made by the Kᵢ Requestor 134 to the Server Subsystem 400 at the Kᵢ Request Receiver 411 service, across the Data Transport 300, where 301 identifies the connections between the Client Subsystem and the Server Subsystem. The Server Subsystem 400 processes the request, communicating internally with the Manifold Object Subsystem 500. When the key has been computed the Server Subsystem 400, Kᵢ Request Return 421 service replies to the Client Subsystem 100 at the Kᵢ Receiver 135 entry point. The Client Subsystem 100 DO Output 137 process saves the DO 210 to file storage as a decrypted data object.

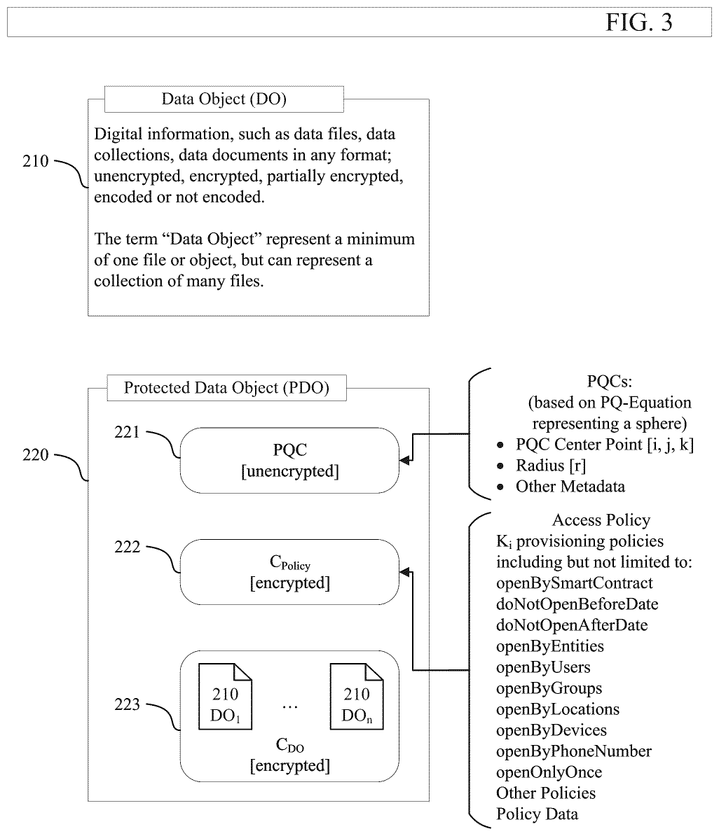

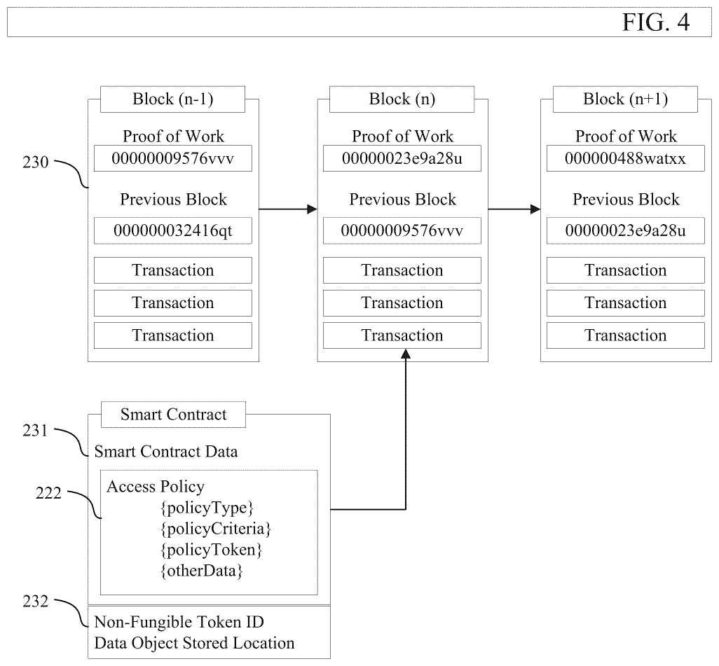

FIGS. 3 and 4 illustrate Data Containers 200 comprising Data Object 210 (DO), Protected Data Object 220 (PDO) and Blockchain Policy Object 230 respectively. The DO 210 can be, but is not limited to, digital information, such as data files, data collections, and data documents in any format; unencrypted, encrypted, partially encrypted, encoded or not encoded. PDO 220 can be, but is not limited to, an archive-like data object, which includes but is not limited to data blocks PQC 221, PDO Access Policies (C_{Policy}) 222, and encrypted DO's (C_{DO}) 223, which permit per-data object encryption with access policies needed to compute Kᵢ. The Blockchain Policy Object 230 are policy instructions and descriptive information that identifies a PDO, formatted to adhere to a blockchain smart contract protocol.

FIG. 3 is a view which illustrates data containers, which are the unprotected and protected data object according to the embodiment of FIG. 1. The PQC 221 data block is inside the PDO, which stores the polynomial/quadratic coefficients necessary to compute K₁. PQC includes the polynomial or quadratic coefficients and other metadata, which, for the exemplar of a sphere, can include Center Point [i, j, k] and radius [r].

PDO Access Policies (C_{Policy}) 222 are instructions which inform the Policy Actions process on the procedures to achieve an intended outcome for the returning Kᵢ to the requesting Client. The following is a non-exhaustive list of possible access policies, which can include but are certainly not limited to: policies affecting dates of use, such as, but not limited to, an “Open by” for instance in a smart contract; a “Do Not Open Before” date; a “Do Not Open After” date to secure a decision window; variables affecting identities such as entities, users, groups, locations, devices, phone numbers and the like, such as an Open By Entities limitation; an Open By Users; an Open By Groups; an Open By Locations; an Open By Devices; additional policies can include authorized user identifiers list, such as an Open By Phone Numbers for a registered user; a frequency, such as Open Only Once; and similar policies and variables. The resulting Encrypted DO's (C_{DO}) 223 are Data Objects, which have been encrypted using a standard encryption algorithm with Kᵢ used as the cryptographic key.

FIG. 4 is a view which illustrates the PDO access policy integrated into a blockchain smart contract with Non-Fungible Token (NFT). The exemplary embodiment of the method is shown, by which the cryptographic system of the instant invention can incorporate a Blockchain Policy Object 230 into blockchain contracts. In the embodiment of the invention shown in FIG. 1, the embodiment can integrate the PDO Access Policy 222, via the Blockchain Policy Object 230, into a blockchain smart contract as a non-limiting example. One non-exclusive example of accomplishing this embeds the PDO Access Policy 222 type, criteria, a token and other data into the blockchain Smart Contract using the encryption process of the instant invention. When the criteria have been met for the selected policy type, the token is released to the Server Subsystem 400, allowing the key generating service to compute Kᵢ for decryption of the PDO. For some data objects, such as legal documents and financial reporting documents, a Non-Fungible Token (NFT) can be associated with the PDO as a digital certificate of authenticity.

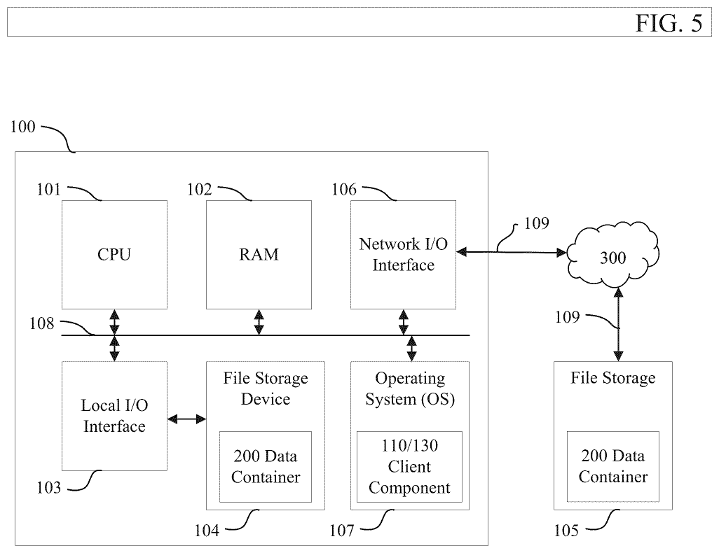

FIG. 5 is a view showing the components of an exemplary embodiment of the client subsystem. In the plan view of a client side of the subsystem it is shown as a network enabled exemplary embodiment of the invention. The Client Subsystem 100 provides a human or machine interface to access a DO or PDO, requests Kᵢ, and encrypts the DO into a PDO or decrypts the PDO. The Client Subsystem 100 can include but is not limited to a CPU 101 for computing and processing, non-persistent memory storage RAM 102, local input/output interface 103 to communicate with client-side hardware and services such as the file storage device 104 and network-like storage devices and services 105 via the network input/output interface 106 across a data transport communication path 109 and 300, the Operating System (OS) 107 and the client communication bus 108. In the non-limiting exemplary embodiment shown in FIG. 5 operating system 107 provides the Application Program Interfaces' (API) for software, such as the Client Components 110 and 130, can access client subsystem resources. In this exemplary embodiment, the client-based software, which may include a User Interface/User Experience (UI/UX) for human or a machine-based interface is used to interact with the DO, PDO, OS, encryption/decryption algorithms and computer components. Collectively, the client components utilize the computer resources to encrypt a DO into a PDO and decrypt a PDO into a DO.

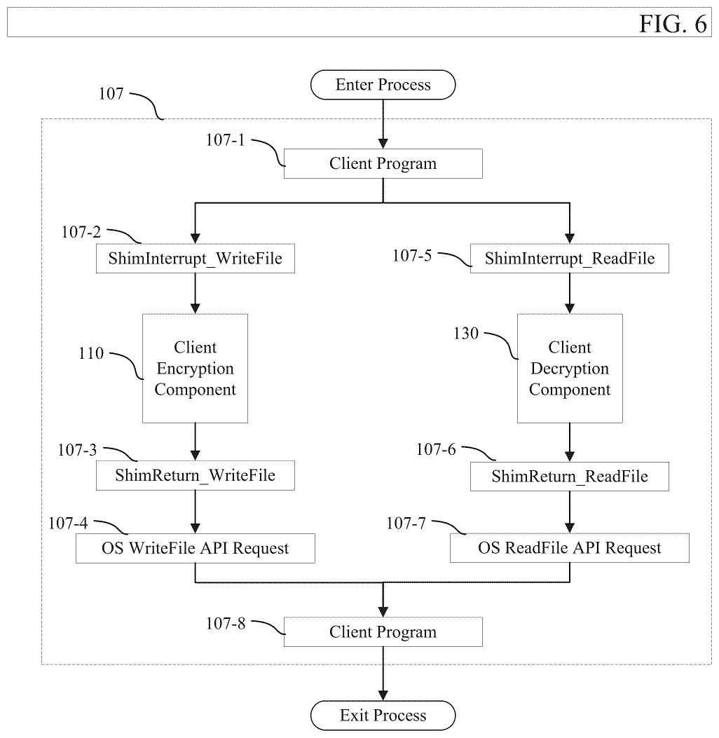

FIG. 6 shows the process flow that illustrates the respective exemplary embodiments of Client Shimming which permits Client Subsystem 100 to interact with standard computer programs by intercepting and redirecting API calls from the operating system to the subsystem. The shimming process boxes the Client Encryption Subsystem 100. This process, when activated in Client Subsystem 100, allows seamless integration with other programs to streamline interaction with client programs, such as but not exclusive of a word processor or similar program, and the operating system to enable to the client programs built-in functions to call Server Subsystem 400 as an action prior to the intended OS action as is well known and understood in the industry. An example of this process would be to use the client program “open” function to open a PDO; however, the shim 107-5 interrupts the OS call ReadFile and executes a separate call to load the PDO into memory and passes control to the Client Decryption Component 130 to transform the PDO into a DO, then returns control 107-6 back to the client program, allowing the program to access the unencrypted data. Shimmed OS Application Server Interface (API) commands include for example, but are not limited to read, write, update, create, delete, and the like. A client shim process is provided as part of the exemplary embodiment where the encrypt and decrypt process are integrated to function with client devices in normal operation as a layer between the operating system and the data objects.

FIG. 6 shows an exemplary configuration of the Client Shimming process; saving a DO to data storage as a PDO and loading a PDO from data storage. In the exemplary configuration where a client program takes action to save a DO to file storage, the ShimInterrupt_WriteFile 107-2 acts as interface between the client program 107-1 and the OS WriteFile API Request 107-4. The client program 107-1 calls to save a DO, is intercepted by ShimInterrupt_WriteFile 107-2 and redirects the call to the Client Encryption Component 110. After completion of the encryption by Client Encryption Component 110, the ShimReturn_WriteFile process 107-3 is returned to the OS WriteFile API 107-4, which then returns control to the client program 107-8. In the exemplary configuration where a client program takes action to open a PDO from file storage, the ShimInterrupt_ReadFile 107-5 acts as interface between the client program 107-1 and the OS ReadFile API Request 107-7. The client program 107-1 calls to open a PDO, is intercepted by 107-5 and redirects the call to the Client Decryption Component 130. After completion of the decryption by Client Decryption Component 130, the ShimReturn_ReadFile process 107-6 is returned to the OS ReadFile API 107-7, which then returns control to the client program 107-8.

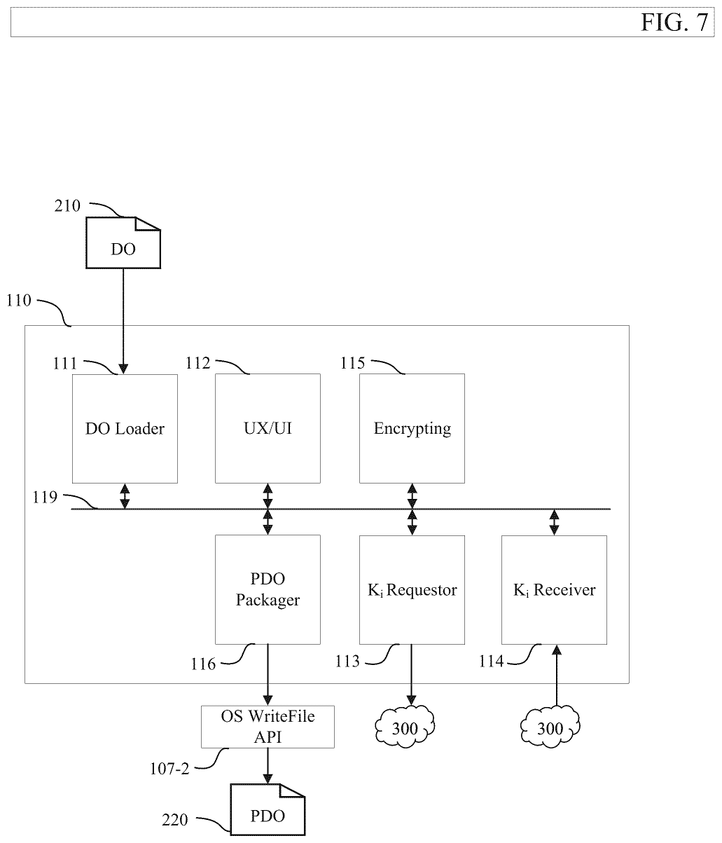

FIG. 7 is a view showing an exemplary embodiment of the client encryption component. It is a non-limiting example of a Client Encryption Component 110. The Client Encryption Component 110 provides a method for users or process to interface with Data Containers 200 and the Server Subsystem 400 in order to perform the functionality in the exemplary embodiment of FIG. 1. Client Encryption Component 110 loads the DO 210, allows the user or process to apply policies, requests the cryptographic key, encrypts Data Objects 210 into Protected Data Objects 220 when called upon by a user, program, or similar process initiating encryption of data and saves the PDO 220 to digital storage. In a non-limiting exemplary embodiment of FIG. 7, the Client Encryption Component 110 can be initiated by a shimming process as illustrated in FIG. 6 or as a stand-alone application operating apart from a shimming process.

In this non-limiting exemplary embodiment, the DO Loader 111 loads the Data Object 210 from file or memory storage, such as, but not limited to, a part of the Random Access Memory (RAM) 102 or temporary storage on a File Storage Devices 104 such as, but not limited to, a hard drive or stored in temporary storage such as remotely on a network drive or the cloud. User Experience/User Interface UX/UI 112, generally idealized as a Graphical User Interface (GUI) or a command line interface to a user or process, or other experience which can include but would not be limited to, voice commands, visual commands, touch commands and similar user inputs, provides a user a method to select Access Policies and attributes to assign to the Protected Data Object 220. The Kᵢ Requestor 113 acts as an interface, via the Data Transport 300, with the Server Subsystem 400 to issue a request for the cryptographic key. The Kᵢ Receiver 114 acts as an interface to receive, via the Data Transport 300, the Transient Cryptographic Key (Kᵢ) and the PQC 221 for the key, from the Server Subsystem 400. The Encrypting 115 process creates a PQC data block, creates an encrypted PDO Access Policy data block (Policy→C_{Policy}), encrypts each DO into a data block (DO_{1, 2, . . . n}→C_{DO}). The PDO Packager 116 assembles each data block into an archive (PQC+C_{Policy}+C_{DO}→PDO) and saves to data storage 107-2. The Client Encryption Subsystem 110 is enabled by the bus 119, which facilitates communication between the processes.

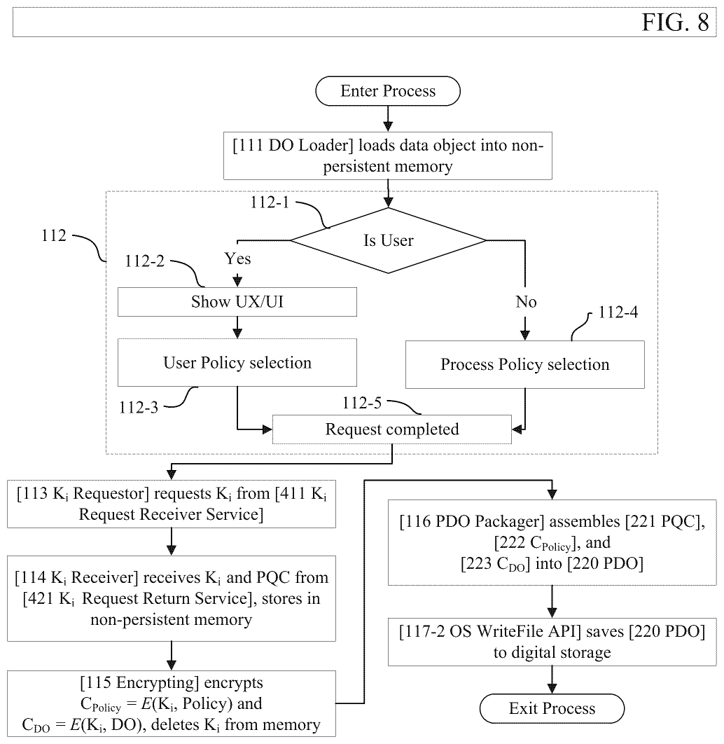

FIG. 8 is a process flow chart view showing an exemplary embodiment of the client encryption process. FIG. 8 illustrates the respective exemplary embodiments of the Client Encryption Process for the non-limiting exemplary embodiments of the invention in FIG. 7. As shown in FIG. 8, the process begins with a call to DO Loader 111, which can include, but is not limited to, a shimming process call from a client program or initiation by a user or a computing process. A step of loading the data object into memory is conducted. The DO Loader 111 loads the Data Object 210 into Random Access Memory (RAM) 102 or temporary storage on a File Storage Device(s) 104. A determination is made as to the type of user 112-1. Depending on the result of the determination, different process paths provide for user selected policies or process policies to be applied during encryption. For instance, if a human is the user 112-1, then a UX/UI is displayed 112-2 allowing the user to make selections, including access policy selections 112-3, otherwise if an automated computing system is used, then the automated process processes the access policy selection criteria 112-4.

After the access policy selection is completed 112-5, a request is made for the cryptographic key. In the exemplary embodiment shown, this is done by the Kᵢ Requestor 113. The Kᵢ Requestor submits a request across the Data Transport 300 to the Server Subsystem 400. A receiving step occurs whereby the key, Kᵢ, and other variables are received by the Client Encryption Component 110. The Kᵢ Receiver 114 receives the Transient Cryptographic Key (Kᵢ), and polynomial and quadradic equation coefficients (PQC) and stores Kᵢ and PQC into non-persistent RAM 102.

An encryption step is performed on the DO to form the PDO. The exemplary embodiment shown has Encrypting 115 process call Kᵢ from, in a non-limiting example, RAM 102 and encrypts the Policy data block as C_{Policy} 222 using Expression (16), where P=Policy and the DO as C_{DO} 223 using Expression (16), where P=DO. When the encryption process is complete, Kᵢ is deleted from memory. Following the encryption step, the PDO Packager 116 assembles the PQC data block 221, C_{Policy} data block 222 and the C_{DO} data block 223 into a Protected Data Object 220 and calls OS WriteFile API 107-2 to save object to file storage.

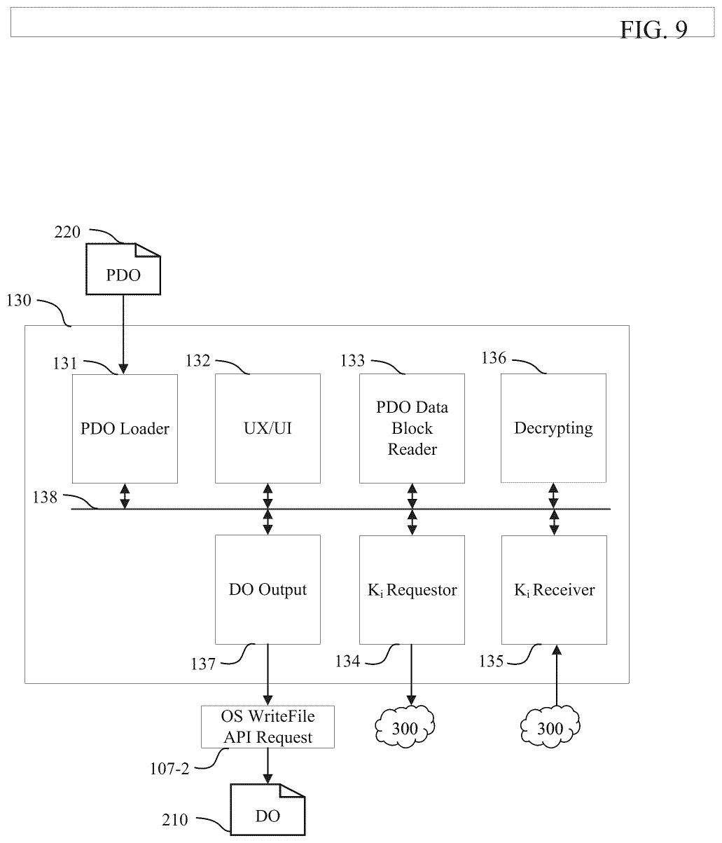

FIG. 9 is a view showing an exemplary embodiment of the client decryption component. The view shows a non-limiting example of a Client Decryption Component 130. The Client Decryption Component 130 provides a method for users or process to interface with Data Containers 200 and the Server Subsystem 400 in order to perform the functionality in the exemplary embodiment of FIG. 1. Client Decryption Component 130 loads the PDO 220, requests the cryptographic key, decrypts Protected Data Objects 220 into Data Objects 210 when called upon by a user, program, or similar process initiating decryption of data and saves the DO 210 to digital storage. In a non-limiting exemplary embodiment of FIG. 9, the Client Decryption Component 130 can be initiated by a shimming process as illustrated in FIG. 6 or as a stand-alone application operating apart from a shimming process.

FIG. 9 illustrates the Client Decryption Component 130. In this non-limiting exemplary embodiment, the PDO Loader 131 loads the Protected Data Object 220 from file or memory storage, such as, but not limited to, a part of the Random Access Memory (RAM) 102 or temporary storage on a File Storage Devices 104 such as, but not limited to, a hard drive or stored in temporary storage such as remotely on a network drive or the cloud. User Experience/User Interface UX/UI 132, generally idealized as a Graphical User Interface (GUI) or a command line interface to a user or process, or other experience which can include but would not be limited to, voice commands, visual commands, touch commands and similar user inputs, provides a user a method to respond to Access Policies requests. These requests may include, but are not limited to, providing an alpha-numeric pin, password, biometric input such as face or fingerprint, or other, as required by the Access Policy. The PDO Data Block Reader 133 reads from the PDO, the PQC data block and C_{Policy} data block to submit to Server Subsystem 400. The Kᵢ Requestor 134 acts as an interface, via the Data Transport 300, with the Server Subsystem 400 to issue a request for the key. The Kᵢ Receiver 135 acts as an interface to receive, via the Data Transport 300, the key, Kᵢ, from the Server Subsystem 400. Decrypting 115 process decrypts the CDO data block into unencrypted data objects (C_{DO}→DO_{1, 2, . . . n}). The DO Output 137 saves the decrypted data object to data storage 107-2. The Client Decryption Process 130 is enabled by the bus 138, which facilitates communication between the processes.

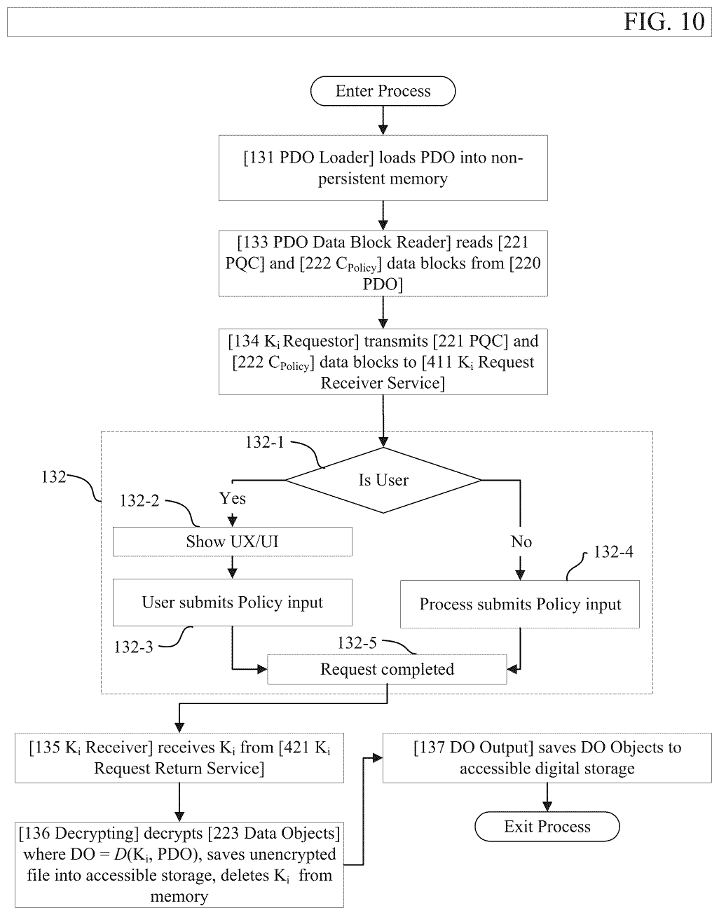

FIG. 10 is a process flow chart showing an exemplary embodiment of the client decryption process. The figure shows the process flow that illustrates the respective exemplary embodiments of the Client Decryption Process for the non-limiting exemplary embodiments of the invention in FIG. 9. On loading of the application, the process begins with a call to PDO Loader 131, which can include, but is not limited to, a shimming process call from a client program or initiation by a user or a computing process for example. A step of loading the protected data object into memory is conducted. The PDO Loader 131 loads the Protected Data Object 220 into Random Access Memory (RAM) 102 or temporary storage on a File Storage Devices 104.

In the exemplary embodiment shown, the PDO Data Block Reader 133 reads the data blocks PQC 221 and C_{Policy} 222 from the PDO 220. The Kᵢ Requestor 134 transmits a request across the Data Transport 300, which includes the PQC 221 and C_{Policy} 222 data blocks to the Server Subsystem 400 to compute the Transient Cryptographic Key (Kᵢ).

A determination is made as to the type of user 132-1. Depending on the result of the determination, different process paths provide for input to user selected policies or process policies, which were applied during encryption. For instance, if a human is the user 132-1, then a UX/UI is displayed 132-2 allowing the user to respond to a policy request, such as an alpha-numeric pin, password, biometric input such as face or fingerprint, or other, as required by the Access Policy 132-3, otherwise if an automated computing system is used, then the automated process processes the policy selection criteria 132-4. The policy response is provided to Server Subsystem 400 to validate the Access Policy has been met.

The Kᵢ Receiver 135 receives the Transient Cryptographic Key (Kᵢ), which is passed to the Decrypting 136 process. The elements of the decryption process principally vary in Decrypting 136 process, which reverses the computational processes of the Encrypting process 115. An embodiment having both the encryption and decryption components in the same physical subsystem is contemplated as well. Decrypting 136 process decrypts the PDO and the DO Output 137 process saves the DOs to file storage 104 via the OS WriteFile API Request 107-2 or saves the DO into RAM 102. The Client Decryption Component 130 is enabled by the bus 138, which facilitates communication between the processes.

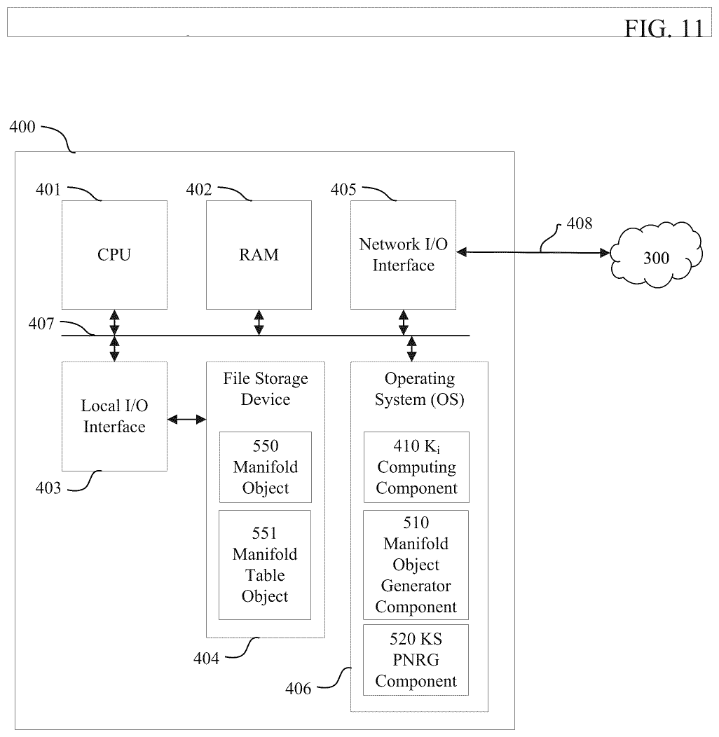

FIG. 11 is a view which shows a non-limiting example of the Server Subsystem 400 of a network

enabled exemplary embodiment of the invention. As shown in FIG. 11, the Server Subsystem 400 can include, but is certainly not limited to, at least one CPU 401 for computing and processing, non-persistent memory storage RAM 402, an at least one local input/output interface 403 to communicate with server-side hardware and services such as the file storage device 404, a network input/output interface 405 across a network communication path 408 and 300, the operating system 406 and the server communication bus 407. The exemplary embodiment of the server runs the various application processes which enable the exemplary embodiment of this invention as described herein above.

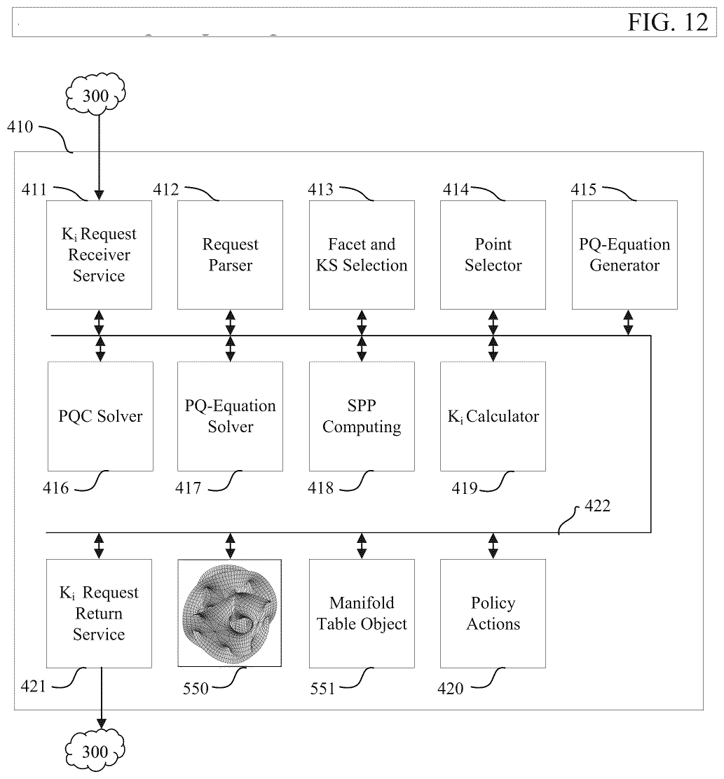

FIG. 12 is a view showing an exemplary embodiment of the Kᵢ computing component according to the embodiment of FIG. 1. A non-limiting example of a cryptographic key generator component of the instant invention is shown, called the Kᵢ Computing Component 410, which can be a component of the Server Subsystem 400, as shown in this exemplary embodiment, coupled to the Data Transport 300. The component obviates the need for a Cryptographic Key Management System (CKMS); however, the cryptographic system does not exclude a CKMS from the system, which can be desirable for authorization to use the Kᵢ Computing Component resources for example.

The Kᵢ Computing Component computes the cryptographic key, Kᵢ, by combining Other Data D₁ or PQC 221, which is held in the PDO 220, accessible only by the Client Subsystem 100, Other Data D₂, or SPP 456, which is computed by the component with PQC as the input to the expression, and K₃. Component key K₃ is held on the Server Subsystem 400 in a protected database, called the Manifold Table Object 551 and is not accessible by the Client Subsystem. The elements, or Other Data, used to compute K₁, after being computed, are stored in the PDO as the PQC data block 221. The PQC is provided to the Kᵢ Computing Component 410 to compute K₁, using Expression (4) in this exemplary embodiment. The component key K₂ does not exist and can only be derived when the Client Subsystem provides the PQC 221 to the Server Subsystem 400 to calculate K₂ from the SPP, using Expression (6). Only when the Server Subsystem possesses K₁, K₂ and K₃ can Kᵢ be computed, using Expression (1), Expression (2) or a combination of the two. The Server Subsystem 400 does not require the PDO to perform the decryption into unencrypted data objects; therefore, confidentiality of the information remains with the client device.

The Kᵢ Computing Component(s) 410 include, but are certainly not limited to, the Kᵢ Request Receiver 411, which receives the request for Kᵢ from the Client Subsystem 100 over the Data Transport 300 as shown in FIG. 12. The Request Parser 412 extracts the data blocks PQC 421 and C_{Policy} 422 from the client request message. The Facet and KS Selection 413 randomly selects a facet used in the computation of a new Kᵢ from the Manifold Table Object 551. The Point Selector 414 randomly computes a geographic point on the facet, represented by (m, n, o) identified as the SPP 456. The PQ-Equation Generator 415, computes the coefficient properties of the polynomial or quadratic equation or surface. PQ Solver 416 solves for the intersection of the equation with the manifold at the SPP, where the SPP is perpendicular to the facet surface. This computation creates a unique point where the SPP can be recomputed, but remains unknown until computed. The PQ-Equation Solver 417 is used to process the PQC coefficients, provided by the Client Subsystem 100, and solve for the polynomial or quadratic equation overlaid onto the Manifold Object 550.

The SPP Computing 418 process computes the SPP on the facet, allowing the Server Subsystem to compute component key K₂. The Kᵢ Calculator 419 computes Kᵢ from the component keys, using Expression (1), Expression (2) or a combination of the two. The Policy Actions process 420 decrypts C_{Policy} and evaluates the policies to determine if the policy conditions have been met. If policy conditions have been met, Kᵢ is provided to the Client Subsystem to decrypt C_{DO} into unencrypted data objects. If policy conditions have not been met, Kᵢ is nullified and the Client Subsystem would be unable to decrypt the PDO. The Kᵢ Request Return 421 service returns the appropriate data to the Client Subsystem over the Data Transport 300. Prior to exiting, the memory is cleared from the results of the process in the exemplary embodiment shown. The Manifold Object 550 and Manifold Table Object 551 are present on the Server Subsystem. The methods communication bus is represented by 422, which permits the subsystem processes to communicate.

This component provides a method to generate a Transient Cryptographic Key (Kᵢ), whose key space has high entropy and randomness with a low memory volume storage need. The mathematical coefficients used to derive Kᵢ are divided into three components; one: PQC, provided to the Client Subsystem for storage into the Protected Data Object, two: the computed SPP value, which is deleted or rendered inaccessible after use, and three: the Key Seed, stored in the Manifold Table Object 551. This method allows Kᵢ to be used then deleted, while permitting a mathematical method to recompute Kᵢ. This process permits a high entropy, random, deterministic symmetric cryptographic key, which can be deleted and recomputed; therefore, the key is ephemeral. While one purpose of the component is to compute Kᵢ, another purpose provides a method to embed key management provisioning policies into the key agreement protocol.

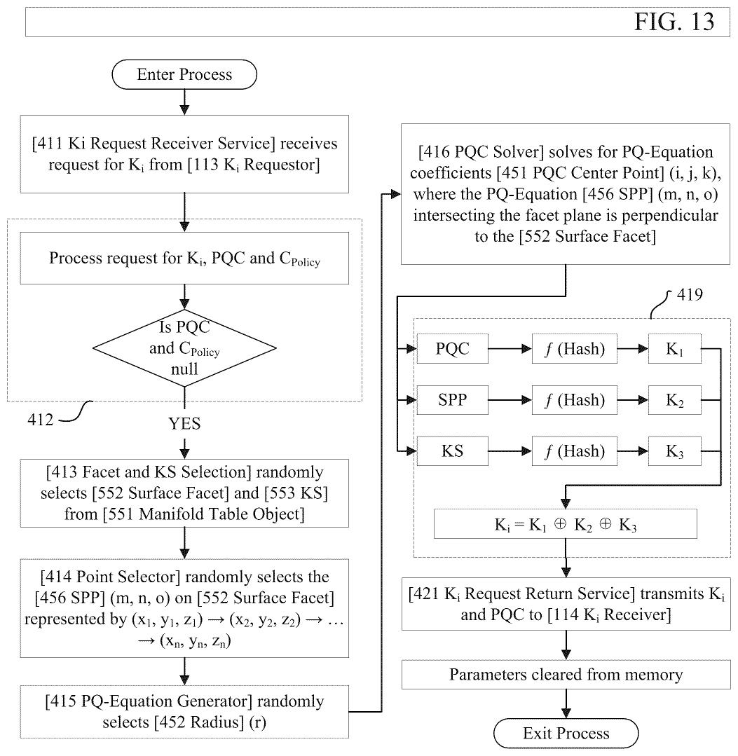

FIG. 13 is a process flow chart showing an exemplary embodiment of the Kᵢ computing process when PQC and C_{Policy} are null according to the embodiment of FIG. 12. The figure shows the process flow that illustrates the respective exemplary embodiments of the Kᵢ Computing Process 410 of the invention generating a new Transient Cryptographic Key in response to a new request. A new key request is called for in a first step. The call for Kᵢ, as shown in exemplary embodiment, is generated by the Client Encryption Component 110 and enters the process at Kᵢ Request Receiver 411 service. A parsing step follows to verify request data. In the exemplary embodiment, the request message is passed to the Request Parser Receiver 412 to determine if data blocks PQC 221 and C_{Policy} 222 are in the message or is null. If there is no verifiable data indicating a former key, then a new key request is made and a facet selection is done. In this example, if the data blocks are null, the request is for a new key, Kᵢ, and the request is passed to the Facet and KS Selection 413 process. The Facet and KS Selection 413 process randomly selects a Surface Facet 552 and its corresponding facet properties and associated Key Seed (KS) 553 from the Manifold Table Object 551, and loads into RAM 402.
Surface Facet 552 properties are expressed:

(x₁, y₁, z₁)→(x₂, y₂, z₂)→ . . . →(xₙ, yₙ, zₙ) (19)

For an exemplary embodiment of the invention generating a new Transient Cryptographic Key in response to a new request, a surface perpendicular point selection step is conducted. In the exemplary embodiment this is performed by the Point Selector 414 process which randomly selects a point on Surface Facet 552 as the Surface Perpendicular Point (SPP) 456 as represented by (m, n, o). This method embodies a sphere as shown in the non-limiting exemplary embodiment of the figure and uses a quadratic surface equation, Expression (15). In this embodiment, the PQ-Equation Generator 415 process randomly selects Radius (r) 452, representing the offset from the SPP to the sphere's center. The PQC Solver 416 solves for the PQ-Equation coefficients;

PQC Center Point 451 is expressed (i, j, k) (20)

The exemplary embodiment then performs an at least one component key calculation step. In the exemplary embodiment, Kᵢ Calculator cryptographic 419 process, using Expression (4), converts the PQC coefficients into K₁, using Expression (6), then converts the SPP coefficients into K₂ and using Expression (8), converts KS into K₃. Upon calculation of all three component keys, using Expression (1), Expression (2) or a combination of both, Kᵢ is computed. The finished key, Kᵢ, is then transmitted in a return transmission process. In the exemplary embodiment, Kᵢ and the PQC 221 are then transmitted to the Client Encryption Component 110 over the Data Transport 300 by Kᵢ Request Return 421 service.

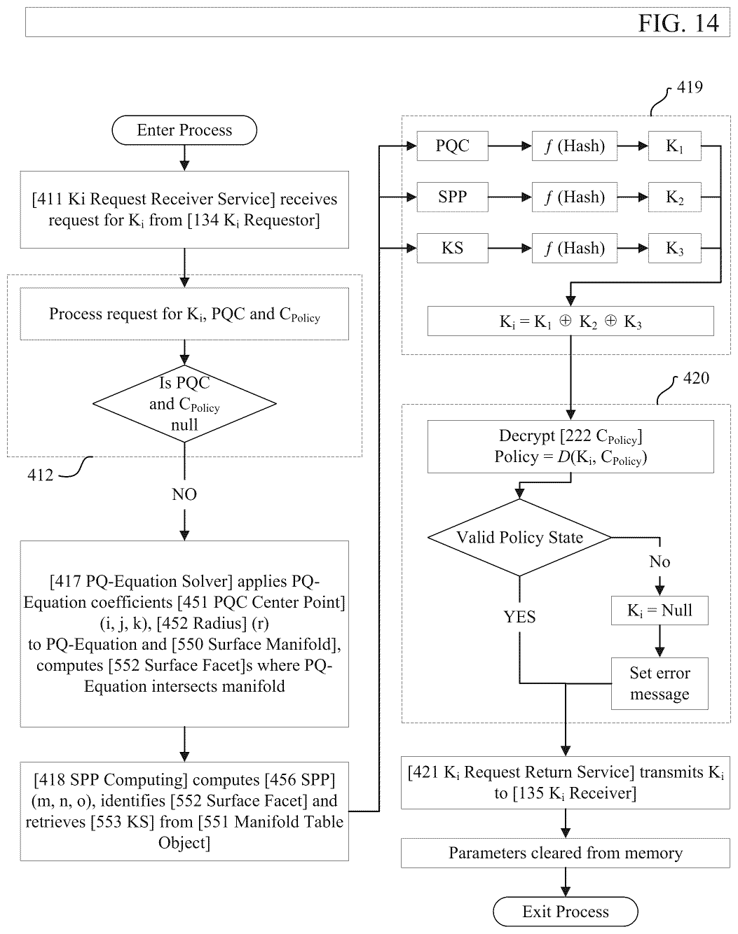

FIG. 14 is a process flow chart showing an exemplary embodiment of the Kᵢ computing process for PQC and C_{Policy} when the values are not null according to the embodiment of FIG. 12. The process flow illustrates the respective exemplary embodiments of the Kᵢ Computing Process 410 of the invention recomputing a Transient Cryptographic Key in response to a request in order to decrypt a C_{DO} into an unencrypted data object. FIG. 14 is similar at the start to FIG. 13; however, a request to recompute the Transient Cryptographic Key is called for in a first step. The call for Kᵢ, as shown in exemplary embodiment, is generated by the Client Decryption Component 130 and enters the process at Kᵢ Request Receiver 411 service. A parsing step follows to verify request data. In the exemplary embodiment, the request message is passed to the Request Parser Receiver 412 to determine if data blocks PQC 221 and C_{Policy} 222 are in the message or are null. After this determination, the data related to the key is sent to a key generating service to reconstruct the key. In this exemplary embodiment, the PQC 221 is passed to the PQ-Equation Solver 417 process. The polynomial or quadratic equations are solved to identify the associated Surface Facet 552 and Key Seed 553 from the Manifold Table Object 551. Using the PQC and Surface Facet properties, the SPP Computing 418 process computes the SPP 456.

A call is then made to a key calculating process. Here, the Kᵢ Calculator 419, using Expression (4), converts the PQC coefficients into Kᵢ, using Expression (6), converts the SPP coefficients into K₂ and using Expression (8), converts KS into K₃. Upon calculation of all three component keys, using Expression (1), Expression (2), or both, Kᵢ is then computed or recomputed or recalculated. After recalculating the key, a check is made against the policies that are stored with the key to determine if release of the key by the Server Subsystem 400 is allowed. In the exemplary embodiment of FIG. 14, the Kᵢ and C_{Policy} 222 are passed to the Policy Actions 420 process. The Policy Actions process, using Expression (17) decrypts C_{Policy} and assesses the policy and action requirements. If the access policy is not met, then Kᵢ is nulled. A nulled key prevents decryption of the PDO, since the key does not represent the key used to encrypt the data object into the PDO. Therefore, the Client Decryption Component 130, or any other process, is prevented from decrypting the protected data objects. If the policy is met, then Kᵢ is then transmitted to the Client Decryption Component 130 over the Data Transport 300 by Kᵢ Request Return 421 service. After transmitting Kᵢ, the parameters used to compute the key are cleared from memory.

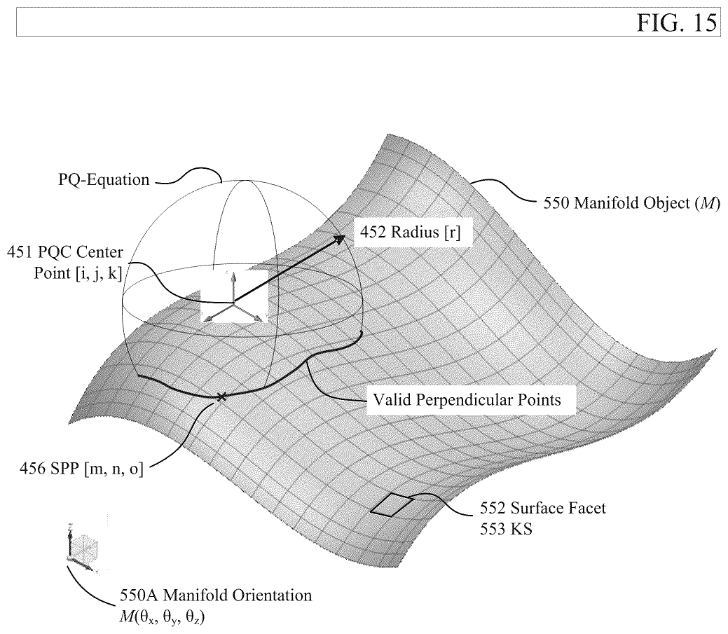

FIG. 15 is a 3-D graphical illustration showing an exemplary embodiment of a PQ-Equation and PQC mapped to the manifold and the facet. The figure shows a 3-dimensional graphical illustration representing the manifold and PQ equation interaction. In the exemplary embodiment of the invention which illustrates the PQ equation, represented as a sphere interacting with a section of the Manifold Surface. The Manifold Object (M) 550 can be represented by, but is certainly not limited to, Expressions (9), (10), and (11), a manifold is defined as topological space that locally resembles Euclidean space, taking a geometric object [symbol] and fitting into [symbol] , n>k and additional properties, such as but not limited to the Manifold Orientation 550A. The Manifold Object is decomposed into Surface Facets 552, which represents a finite closed area and can be represented by three or more vertexes that define the area, represented by Expression (12). Each Surface Facet 552 is assigned a Key Seed 553. The Key Seed adds additional security to the cryptographic system by ensuring an unknown random value is added to the key generating process to prevent future ultra-high-performance computers or novel techniques from arbitrarily computing the total key space defined by the PQ-Equation.

The PQ-Equation, in this and other exemplary embodiments can be represented by a polynomial, idealized in Expressions (13), a quadratic equation, idealized in Expressions (14) representing a one-dimensional curve or closed curve and/or a quadratic surface, idealized in Expressions (15), such as a sphere or ellipse. The coefficients of the PQ-Equation, are represented by PQC 221. As illustrated in this embodiment, these properties derive from, but not limited to, those of a quadratic sphere, the properties of the PQC include the spheres PQC center 451 and the spheres Radius 452 as non-limiting examples. The PQ-Equation can intersect the manifold at an n-number of exclusive locations, however, SPP 456, can be computed when combining the PQ-Equation and the PQC with the Manifold. In this embodiment as described, the SPP is a point where the PQ-Equation intersects the manifold surface facet and is perpendicular at the intersection; however, the SPP could be defined as a tangent or other defining mathematical property.

Although a sphere and radius solution are depicted in the non-limiting exemplary embodiment of the instant invention shown in FIGS. 13, 14 and 15, additional embodiments can utilize different geometric shapes and equations to establish the facet and intersection points between the PQ Equation and the Manifold and used in determining the SPP solution outlined herein below. This can include any polynomial or quadratic equation for instance, but is certainly not limited to, a line, a curve, an ellipsoid, a toroid, a cone, and similar geometric shapes and equations. For instance, in the case of a circle, the properties that describe the one-dimensional line in 3-dimension space, such as its center point, the angle of rotation along the axis, and radius could be used to uniquely identify a point where the circle crosses a manifold and is perpendicular at the manifolds surface. The properties that describe the circle would be stored as the PQC in the PDO.

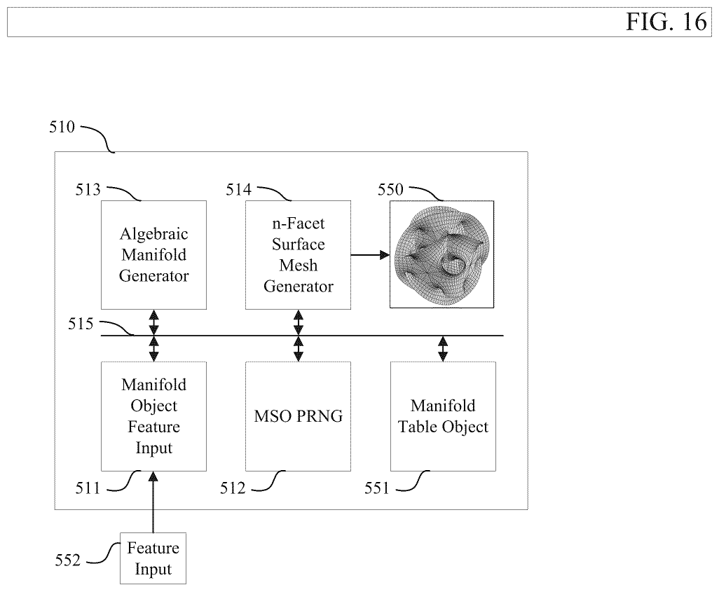

FIG. 16 is a view which shows a non-limiting example of a Manifold Object Generator Component generating a manifold as seen in FIG. 15. The component described is a non-limiting exemplary embodiment and generates a Manifold Object (V) 550. The components can include but are not limited to at least one Manifold Object Feature Input 511, at least one Manifold Seed Object Pseudo Random Number Generator (MSO PRNG) 512, at least one Algebraic Manifold Generator 513, at least one n-Facet Surface Mesh Generator 514, at least one Manifold Object 550, and at least one Manifold Table Object 551. Additional components can be included and some elements, for instance the Manifold Object Feature Input 511, can be varied or automated without departing from the spirit of the invention. The Manifold Object Generator Component operates to provide the manifold used in the encryption of the instant invention. It includes generating a n-Facet surface mesh on the manifold object, creating and storing a table of facets in an at least one manifold table object for lookup and manipulation in the encryption process.

The exemplary embodiment shown allows a user or process to provide Feature Inputs 552 into M, which can include but are not limited to, the Manifold Orientation 550A, dimensionality M( [symbol] ), maximum average dimensional aspect of a Surface Facet 552 and similar variables. The system can allow for user input to select the variables or the system can automatically and randomly select the variables. The MSO PRNG 512 process generates the Manifold Seed Object 512C, used by the Algebraic Manifold Generator 513. The Algebraic Manifold Generator 513 generates the manifold, M, in 3-dimesional Euclidean space, the n-Facet Surface Mesh Generator 514, which uses finite element and surface generation techniques, generates Surface Facets 552 over the manifold. The elements of the Manifold Object 550, which is an output of the Manifold Object Generator and the n-Facet Surface Mesh Generator 514, are saved into the Manifold Table Object 551, which is a database that stores the data required for the component to compute the SPP.

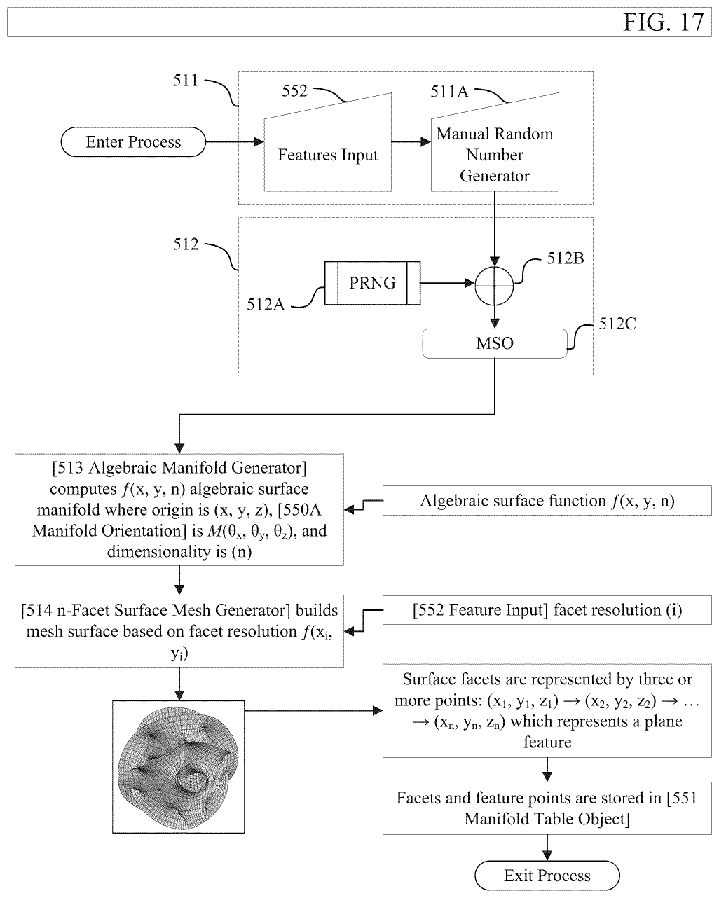

FIG. 17 is a process flow chart showing an exemplary embodiment of the manifold object generator process of FIG. 16. The figure shows the process flow that illustrates the respective exemplary embodiments of the Manifold Object Generator Process 510. The process begins with the step of obtaining input for the features of the manifold. In FIG. 17, the process enters at the Manifold Object Feature Input 511, which provides the user or process a UX/UI to input the Manifold Object Features 552 for the system, including, but not limited to, Manifold Orientation 550A, dimensionality M ( [symbol] ), and maximum average dimensional aspect of a Surface Facet (i) and the like.

Randomness in creation of the manifold aids in security. The process contemplates both user input and machine input to aid in randomizing the manifold features. In order to prevent Pseudorandom Number Generator (PRNG) process from generating predicable random numbers, a Manual Random Number Generator 511B (MRNG) may be presented to a user and random inputs can be provided by the user. Random inputs can include, but certainly are not limited to, mouse movement, keyboard keystrokes, visual inputs, sound inputs and the like to generate a seed number which is entered into the Manifold Seed Object (MSO) PRNG 512.

The MSO PRNG 512 takes the Manual Random Number 511A and performs an Exclusive-Oring 512B with a randomly generated number from the PRNG 512A, outputting the Manifold Seed Object (MSO) 512C. The MSO is used as the seed to the random generators used in the mathematical processes to build the Manifold Object 550 and the Surface Facets 552. Once the at least one data selection/input step is completed, computational extrapolation can begin. The Algebraic Manifold Generator 513 computes M, where the inputs can include but are not limited to origin M(x, y, z), the orientation M(θₓ, θ_{y}, θ_{z}), and dimensionality M( [symbol] ).

A process of model generation is conducted. The n-Facet Surface Mesh Generator 514 uses mathematical finite element and surface mesh algorithms to convert the smooth mathematically described manifold surface into a surface made up of planar facets, described as a Surface Facet 552. The Surface Facet 552 maximum average dimensionality is provided by a user or process input, where the facet resolution is f(xᵢ, yᵢ). Each Surface Facet can have three or more vertexes that define the surface, as represented by Expression (12). Once generated, the Surface Facets and defining properties are stored in the Manifold Table Object 551 as described herein above in the exemplary embodiment shown in FIG. 17.

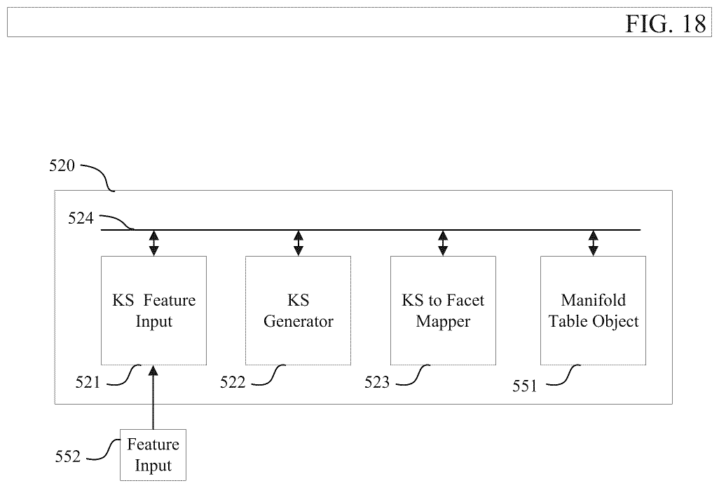

FIG. 18 is a view showing an exemplary embodiment of the KS pseudo-random number generating component The figure shows a non-limiting example of a KS PRNG Component as shown in FIG. 1. The KS PRNG Component 520 generates unique Key Seeds (KS) 553 for each Surface Facet 552 in the Manifold Table Object 551. The exemplary embodiment of the component can include but is not limited to an at least one KS Feature Input 521, an at least one KS Generator 552, at least one KS to Facet Mapper 553, and a process communication bus 524. Additional processes can be included without departing from the spirit of the invention. The Manifold Table Object 551 is accessible by the component to read the Surface Facet table, for storing the associated KS and for other data without departing from the spirit of the invention.

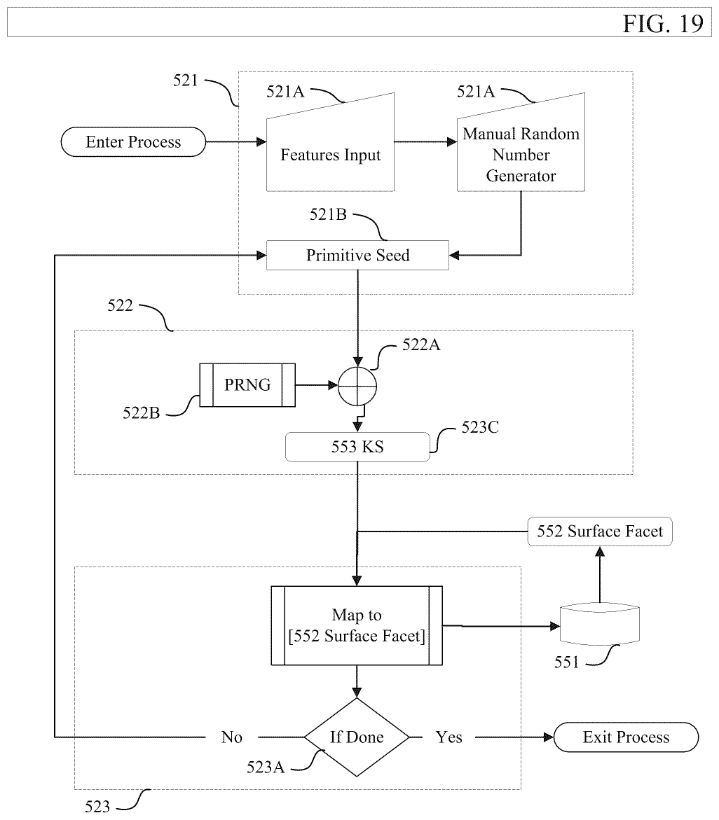

FIG. 19 is a process flow chart for an exemplary embodiment of the KS pseudo-random number generating process of FIG. 18. The process flow illustrates the respective exemplary embodiments of the KS PRNG Process. This is a process to randomly generate key seed data elements. As seen in FIG. 19, the process enters at the KS Feature Input 521, which provides the user or process a UX/UI. In order to prevent Pseudorandom Number Generator (PRNG) process from generating predicable random numbers, a Manual Random Number Generator 521A (MRNG) is presented to a user and random inputs can be provided by the user. Random inputs can include, but certainly are not limited to, mouse movement, keyboard keystrokes, visual inputs, sound inputs and the like to generate the Primitive Seed 521B which is entered into the KS Generating 522 process.

The Primitive Seed 521B is an unknown value of length k, or kLen. AES256 cryptographic key has a Kᵢ kLen of 256 bits. The KS Generating 522 process takes the Primitive Seed 521B and performs an Exclusive-Oring 522A with a randomly generated number from the PRNG 522B, outputting a KS 553. The KS to Facet Mapper 523 maps each KS to a Surface Facet 552 stored in the Manifold Table Object 551. This process repeats 523A until all Surface Facets 552 have a uniquely assigned KS 553.

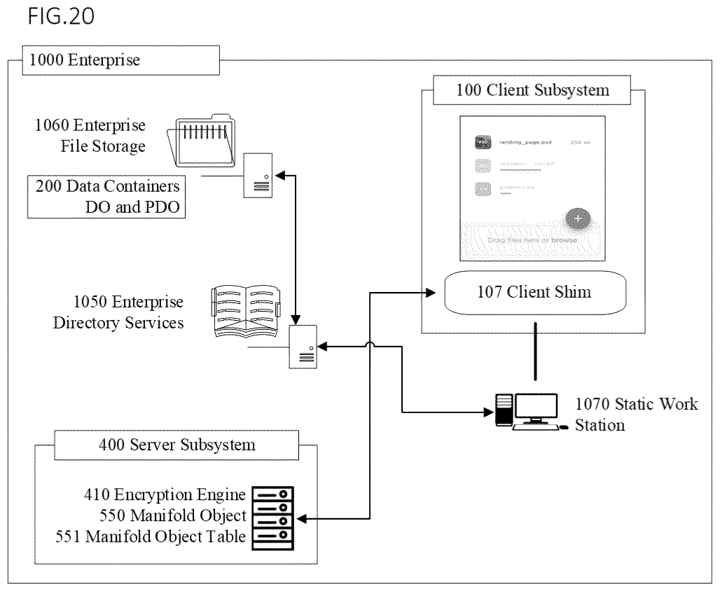

In operation, a number of embodiments of the instant invention are contemplated that would employ the cryptographic system, some non-limiting examples appear as described herein in relation to FIGS. 20-22. For instance, in an enterprise cryptographic security system, such as those utilized by large defense contractors working on Department of Defense (DoD) project development an embodiment of a system utilizing the instant invention could be deployed to prevent espionage.

FIG. 20 shows an exemplary embodiment of the instant invention as a component of an enterprise data network system. In an exemplary embodiment of the invention as shown in FIG. 20, the large defense contractor can install the instant invention as an enterprise wide cryptographic system 400 in their enterprise data network 1000 with an automated security application to protect and make accessible documents related to the DoD projects when employees seek to open a document or save the document from a terminal. If, for instance in a non-limiting example, a disgruntled worker has been hired away by a primary competitor of the defense contractor and she plans to take with her relevant documents that would help her new employer, the deployment of such a system would prevent the theft of the information directly as computer files using the encryption system and methods of the invention.

In this instance the client subsystem 100 can reside on the server workstation 190 maintained by

the large defense contractors and, as noted, a back-end security application, such as a managed directory service, 195 can govern and control access to and use of the stored, encrypted documents on the secure storage 200 or secure storage capacity on the servers 221. As a part of the application and related services provided, the application or client program 195 communicates a call for a DO or PDO and the call is directed via a shim process 107 to communicate with a cryptographic server subsystem 400 on which the encryption engine 410 and Manifold Object Subsystem 500 resides in this example. The large contractor retains a manifold exclusively within the overall enterprise server architecture for the company and can select the parameters of the manifold (M), but the service, as shown, can maintained on another/separate remote and protected set of servers for additional security. The service using the client is engaged at the point of receipt to perform an initial encryption on the DO to a PDO and to store same, the storage being performed for example during data entry by the client subsystem 100 engaging the cryptographic system 400 for a key upon receipt or transmission and stored in an encrypted state on secure storage data containers or a secure storage capacity on the server 200, 290 or the like.

When, for instance a protected technical document is accessed, a call is initiated by a client to retrieve it as an encrypted PDO. The PQC and the encrypted policy is extracted from the PDO and submitted to the server 400 to generate the Transient Cryptographic Key and determine what policy limitations are met or not met as noted above in FIGS. 1-19. The policy components can include any of the non-limiting examples as noted above, for instance in an organization that uses managed directory services, the policy could include User, Group, Computer, etc. identifiers, allowing authorized groups, e.g. Accounting but not Engineering—to access a document, only certain computers in Engineering to access certain drawings, and the like.

In the case of decryption, the server utilizes the PQC to recompute the Transient Cryptographic Key. The system decrypts the encrypted policy to verify and validate the policy has been met, and if so, returns the Transient Cryptographic Key to the requesting client. The client receives the Transient Cryptographic Key and decrypts, makes accessible, the technical document to the user. Though shown as a single engine, more than one encryption engine can exist and a server subsystem encryption engine can be used to encrypt components, such as policies, for storage with the PDO. In the case of encryption, the encrypted access policy criteria are stored with the protected data object. Once the policy elements are set if encrypting or satisfied if decrypting, the key is released and provisioned to the client to decrypt the C_{DO} into a DO. After the client decrypts C_{DO}, the transient key is then discarded or rendered unattainable as noted throughout this specification.

As noted, when a client within the client system residing on the servers of the large contractor calls for a document, the service automatically decrypts the document within the application but prevents transfer and modifications without re-encryption, doing so near instantaneously at speeds not achievable by hand calculations. The encryption engine 410 utilizes each of the key subcomponent values K₁-Kₙ, in this case K₃, to compute the transient key. In this instance, if the bad actor, against company policy, brings a thumb-drive in and downloads the protected files, since her new employer does not possess access to the proper secret manifold or the facet information, they are incapable of computing the encryption keys to decrypt the stolen documents.

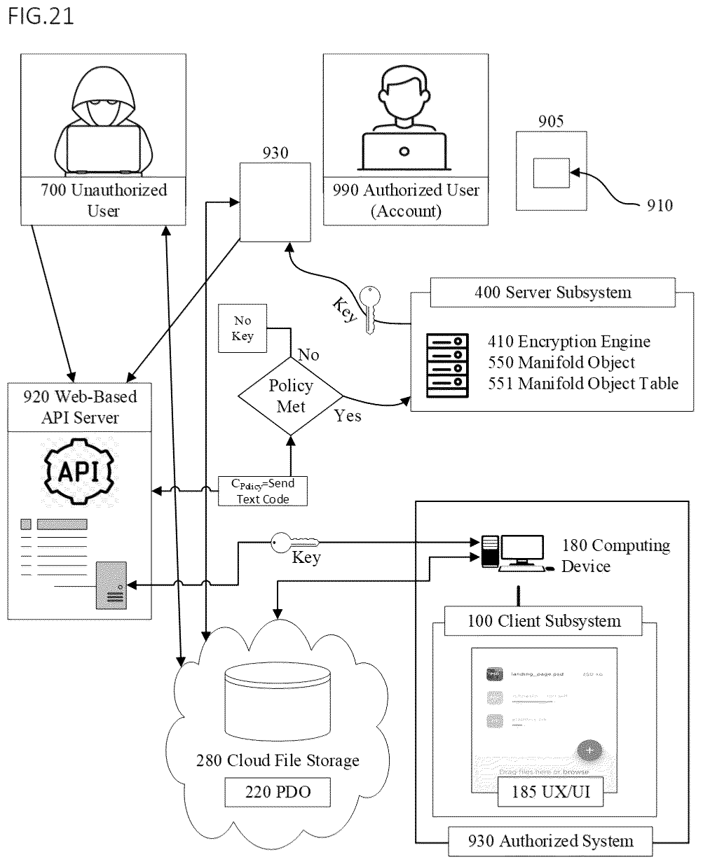

FIG. 21 shows a further exemplary embodiment of the instant invention as a key provisioning service for encryption to secure documents in a cloud storage server. A further application exists in secure storage in commercially available spaces, like cloud drive storage as an encryption engine as part of an application to enhance secure transfer of documents. For instance, the system can be configured for use as a cryptographic system ensuring secure transmission and storage of financial documents between a sender and their Accountant for instance through such a cloud drive service.

Even though the cloud storage system 280 provides a level of security, through obfuscated web links, the Sender needs to send the link via his email to his Accountant. A malicious actor could intercept the email transmission of the documents or data regarding secure storage of same. In this example, a cloud storage system 280 (DROPBOX, GOOGLE DRIVE, or the like) is shown. Documents stored on the cloud storage system 280 are shared via a secure, obfuscated HTML link. However, should the email with the web link to the documents be leaked or otherwise compromised by or to a malicious actor, they would be able to access the accounting documents.

To enhance security, in the exemplary embodiment shown in FIG. 21, the sender opens an associated security application on a computer or computing device 180 or on an API server 920 coupled to the computing device 180. The security application on the API server 920 is then connected to the cryptographic server subsystem 400 of the exemplary embodiment for key provisioning for the encryption. Through a UI/UX 185 coupled to the computing device 180 the sender selects a policy, as a non-limiting example, which will send a random number pin to a cellular phone 905 by SMS Text message 910 for authentication by the authorized user 990, here the accountant, as described herein below.

The client subsystem 100, through the security application web based API server 920, makes a call to the cryptographic server subsystem 400. The call includes the selected policy data for a cryptographic key to protect the document(s). The key is returned with the other data representing the policy data blocks and PQC are returned via a secure connection which can be an encrypted communications channel or tunnel for instance. The encrypted communications channel or tunnel is a Secure Socket Layer (SSL). In other embodiments, a separate encryption can be applied for secure transmission of the key. Using the selected policy data and generated key elements for the transient cryptographic key, the server securely returns the key and the PQC to the client for encryption. The policy data and the transient cryptographic key are transmitted securely to the Web-Based API server 920 which applies and encrypts the data object on the computing device 180 using the client subsystem 100 thereon and the transmitted data. Thus, in this case, using the transient cryptographic key sent by the cryptographic server subsystem 400, the encryption/decryption engine, here shown, but not limited to, residing on the client subsystem 100, completes the encryption with the policy and PQC components into the protected data object, in this case the fully encrypted accounting files. The sender then uploads the secured document to cloud storage 280, as shown, from the computing device 180.

A web link, from the cloud service is sent to the Accountant via email; however, as shown the malicious actor 700 gets access to the email link. The malicious actor 700 downloads the documents to their computer 710 and attempts to access the protected document by requesting the transient cryptographic key Kᵢ from the cryptographic server subsystem 400. However, due to the policy selected by the sender, the malicious actor cannot solve the cryptographic system challenge when the downloaded PDO connects to the cryptographic system 400, which requires a pin to be provided as the policy challenge before the cryptographic system provisions the transient key to the calling client to decrypt the file. Since the malicious actor 700 is not included in the stored policy information—e.g. the text number(s) associated with the pin and stored in the encrypted policy and therefore, the malicious actor is not provisioned the key and cannot open the protected documents.

Moreover, the nature of the encrypted data is such that the key is not contained in the data as downloaded and only by accessing the cryptographic server subsystem 400 would a key be generated. Brute force attempts to access the encrypted PDO and PQC are as a first stage, protected by the encryption of that data. Additionally, even if the data were retrieved, it would still require authorization at the server subsystem 400 and association/identification. Then, even if the PQC were identified, brute force attempts to reconstitute the key would not work from the PDO/PQC data since there is no information as to the shape of the Manifold, the facet data, or the random hash number associated with the key seed and conceivably no means for randomly guessing the shape, plus the facet, plus the random seed information to recreate the key. In sum, there are multiple levels preventing discovery of the key subcomponents and security layers invoked at each of the several component steps that would be required to discover the full encryption key, rendering the system very robust. Additionally, by design, it provides a very large set of possible keys, providing the breath necessary to encrypt a large volume of data. Finally, it is easy to deploy and use and integrate with existing symmetric encryption solutions and products.

The accountant as an authorized user 990 also receives the link. As the authorized receiver, she also commences a download of the protected documents from the cloud service 280 and then initiates a request for the Transient Cryptographic Key to decrypt the document through the web-based API server 920. Using the security application associated on the web based API Server 920 which communicates with the cryptographic server subsystem 400 and the cloud file storage system 280. With the PDO 220 downloaded and an instruction sent for decryption, initiating a call from their computer. The accountant selects the documents to be decrypted by the cryptographic engine 400. However, since as noted in the policy, the system first interprets the PDO data and as a result transmits a pin to the accountant's cellular phone 900 by SMS Text 910. The accountant uses the pin to answer the policy challenge. If the pin is valid, the cryptographic system begins provisioning the cryptographic key to the client being used by the accountant, which then decrypts the protected document on the client device of the accountant, for instance their tablet 930 as shown.

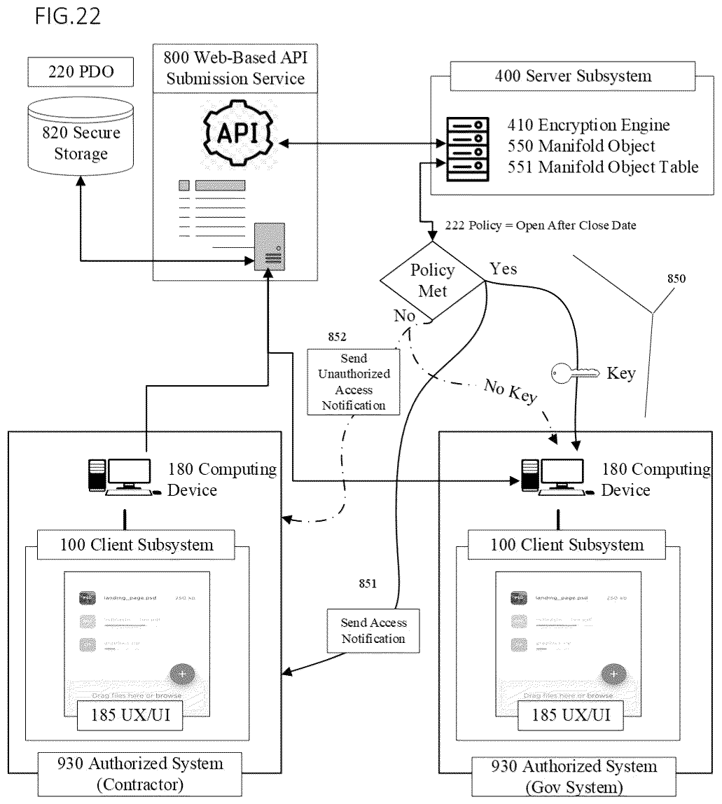

FIG. 22 shows an exemplary embodiment of the instant disclosure as a key provisioning service for a cryptographic system used as a third-party application for submitting secure, encrypted bids for contracts with access date restrictions. In this instance, a problem exists in managing documents stored on servers with specific stated deadlines to access or other policy features that might be leveraged by bad actors for competitive advantage. For instance, in the case of government bidding on public works projects and the like, a general contractor is submitting a proposal to the county for a public works project that is due on a date certain. The bid when submitted is supposed to remain closed until the submission period is completed and must be received before a date certain. Should the proposal be submitted after the acceptance window closes, then the proposal cannot be selected.

However, there have been cases where early submissions have been opened and the contents of the proposal shared with competitors of the contractor and the submitter has security concerns from this. Although illegal, this inappropriate activity is hard to prove since it is hard for the contractor to gain access to evidence, should it exist. A common method to counter this risk is for a contractor to submit the proposal as close as possible to the acceptance window, at the risk of being late.

To remedy this problem, using an exemplary embodiment of the instant disclosure, a bid proposal can be encrypted using the cryptographic system 400 of the instant disclosure and transmitted as a PDO 220 and with Access policies 222 with a date limiter preventing provision of the cryptographic key to decrypt the protected bid until after the policy date has been met.

The PDO 220 is submitted via the submission application used by the government entity and stored on the government entities servers as an encrypted, protected file. As it is encrypted it requires that it be opened with an application or service that communicates with the cryptographic system 400 to provision the Transient Cryptographic Key. The key can only be provisioned and the file opened per the Access policies 222 stored with the PDO, in this instance only after a date certain as indicated in the Access policies 222, with the cryptographic system 400 by the government entity as a receiver.

The county can receive electronic proposals which are each encrypted as a PDO with a separate and unknown cryptographic key and with an access policy limitations that do not provision the keys to decrypt the documents before the acceptance window closes. Once the acceptance window closes, the county can use the cryptographic system to request keys to decrypt proposals for the project, ensuring that malicious passing of proposal details cannot happen due to the submission.

The Client Subsystem 100 can be managed by the government entity or a third party as a submission platform, here shown as a web based API submission service, 800 to receive the data and in the process of submitting the bid submissions of the contractor entities. The government entity run service or third-party service 800 would maintain the Manifold Object 550 and the Manifold Object Table 551 on a server 400 in communication with the Client Subsystem 100. As noted, the PDO Access Policies (C_{Policy}) inform the Policy Actions process on the procedures to achieve an intended outcome for the cryptographic system 400 returning Kᵢ to the requesting Client when decryption is requested. In this case, the PDO Access policies 222 would include with “Do Not Open Before Date” with the date coinciding with the terminus date for submissions. This would guarantee that unauthorized access by either government entity users or third party actors trying to access the bid would be prevented by the cryptographic system and the secure encryption of the bid.

As noted, once the policy is enacted, the request for an encryption key (Kᵢ) would not be allowed based on the date restriction within the PDO as a part of the PDO Access Policies (C_{Policy}) before the bid close date. The cryptographic system 400, upon a call from a submission client or government client application to the web based API system 800 accessing the government server 820 storing the PDO 220, such as when a government actor accesses the file, the API is opened and would transmit a call through an application or shim process, as described herein throughout, to the cryptographic system 400. With the initial submission happening before the close date, similar to the embodiment shown in FIG. 8, if the Access policies 222 are not met for instance an access call before the bid close date, the transient key (Kᵢ) is not returned.

In addition, if additional security is desired, as with the other examples herein without one of the subcomponent key components the data cannot be accessed. The lack of access and separation of the Manifold seed key and the SPP information means decryption could not be achieved by third party actors/unauthorized actors. An added benefit is that multiple access policies can be used to tailor unique access restrictions and notifications, such as an originator requiring a pin or password or be notified when a request to open the document has been made in addition to an access policy restriction that only permit the provision of the cryptographic key after the bid close date as seen at 850. In this instance, on the date of the open date example, the Government Entity would require a pin or password from the Contractor to be provisioned the cryptographic key. For additional security or for compliance purposes, the Contractor would receive a notification, by email, as shown at 851, that the government entity requested access to the protected file after the official open date. If this was done prior to the open date, it would be logged, as seen at 852, and an unauthorized access attempt e-mail sent, allowing traceability and strengthening the reliability and trust within the bidding system. This would ensure their bid would remain secure from even an overzealous or unscrupulous government official if filed early.

Further embodiments are contemplated for instance to address problems in secure data communications in a battle space using security codes that are above current MILSPEC (U.S. Military Standard) standards and further ensuring the security of encrypted systems, another embodiment is contemplated to address secure storage and transmission of medical records with, again, improved encryption standards that render it impossible to use brute force attacks to access the records and allow secure sharing between doctors' offices, a system for supplying a smart contract with an acceptance date deadline as noted above, as well as verification of or authentication of a block chain component(s) stored securely for instance with a piece of art, and similar problems that require a more robust encryption system and that would benefit from added data access policy management and the like.

The term “and/or” when used herein, for example, in a form such as A, B, and/or C refers to any combination or subset of A, B, C such as (1) A alone, (2) B alone, (3) C alone, (4) A with B, (5) A with C, (6) B with C, and (7) A with B and with C. The terms “including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. can be present without falling outside the scope of the corresponding claim or recitation. As used herein, when the phrase “at least” is used as the transition term in, for example, a preamble of a claim, it is open-ended in the same manner as the term “comprising” and “including” are open ended.

To the extent that processes are indicated, the relative order and execution to the process is non-limiting in its explanation as an example and additional steps or process can be included in the overall process without departing from the spirit of the invention whilst reading on to the steps enumerated in the claims of the invention. As would be understood by one of ordinary skill in the invention.

The embodiments and examples discussed herein are non-limiting examples. The invention is described in detail with respect to exemplary embodiments, and it will now be apparent from the foregoing to those skilled in the art that changes, and modifications can be made without departing from the invention in its broader aspects, and the invention, therefore, as defined in the claims is intended to cover all such changes and modifications as fall within the true spirit of the invention.

What is claimed is:

1. A method of providing a transient cryptographic key to perform cryptographic functions including encryption and decryption on a data object in a data network, comprising:
accessing the data object within the data network;
issuing a key request;
requesting from a secure manifold server a manifold, a manifold mesh comprised of facets, and an at least one manifold table object representing the manifold and the manifold mesh facets, and a set of associated identifiers with information representing each facet stored in the manifold table object;
generating randomly an initial key seed value;
determining an at least one facet on the manifold surface from the at least one manifold table object in combination with the initial key seed value;
locating a facet location;
generating a polynomial or quadratic equation with an at least one polynomial or quadratic equation coefficient;
solving for an at least one surface intersection point whereby the polynomial or quadratic equation is solved at the facet location such that the surface point is calculated at an interface of the at least one polynomial or quadratic equation and the manifold object as a surface intersection point;
generating a transient encryption key using at least the combination of the surface intersection point solution in combination with a key seed identifying the at least one facet and the at least one polynomial or quadratic equation coefficients;
transmitting the transient encryption key together with an at least one unique subcomponent key identifier;
rendering the key unavailable and irretrievable as a unitary key; and
returning the protected data object without an available unitary key on or in the protected data object or stored on the system.

2. The method of claim 1, wherein the issuing of the key request is from a cryptographic engine on a client in the data network.

3. The method of claim 1, wherein requesting the manifold from the secure manifold server further comprises selecting from the secure manifold server the manifold.

4. The method of claim 3, wherein selection of the manifold from the secure manifold server is made through input from a user interface.

5. The method of claim 3, wherein selection of the manifold from the secure manifold server is made automatically by the system.

6. The method of claim 1, wherein the facet location is located on the facet on the manifold based on the set of identifiers for the determined at least one facet

7. The method of claim 1, further comprising locating a center of the generated polynomial or quadratic equation based on the at least one polynomial or quadratic equation coefficient.

8. The method of claim 1, further comprising transmitting the transient encryption key to a cryptographic engine in the data network that requests the transient symmetric cryptographic key for encrypting the data object, the cryptographic engine using the calculated transient cryptographic key to form a protected data object together with an at least one encrypted unique subcomponent key identifier.

9. The method of claim 1, wherein rendering the key unavailable and irretrievable as a unitary key is done so that without at least the stored at least one subcomponent key identifier and access to the securely stored manifold object table.

10. The method of claim 1, wherein generating a transient encryption key further includes passing the at least one of the at least one polynomial or quadratic coefficient, the key seed, and the surface intersection point through a hash function.

11. The method of the claims 1, wherein the surface intersection point is one of a tangent point or perpendicular point in reference to the intersection between the surface representing the polynomial or quadratic equation and the manifold.

12. The method of claim 11, wherein surface intersection point is a perpendicular point.

13. A cryptographic computer server on a computer network system for securing a Data Object (DO) as a Protected Data Object (PDO) by encrypting the data object with a transient symmetric encryption key (Kᵢ), comprising:
a secure storage device configured to protect confidentiality of the information held in a data object;
a computing device configured to operate an encryption engine to execute a set of instructions so that the encryption engine derives a transient symmetric encryption key, generates a set of deterministic values to recreate the transient symmetric encryption key and communicating with the secure storage device; and
a data transport configured to securely transmit the encryption key to a key requesting application, wherein the requesting application uses the transient symmetric encryption key to encrypt the data object into the protected data object on the secure storage device, destroys or renders the symmetric key unavailable, and stores the deterministic values to regenerate the symmetric key without storing the key.

14. The cryptographic computer server of claim 13, wherein the computing device is further configured to call the protected data object from the secure storage device, encrypts the at least one data object called from the secure storage device to render the at least one protected data object and destroys the transient symmetric encryption key and stores the set of deterministic values to recreate the transient symmetric encryption key.

15. The cryptographic computer server of claim 13, wherein the computing device is further configured to operate a decryption engine to execute a set of instructions so that the decryption engine receives a request for decryption, retrieves the set of deterministic values for the transient symmetric encryption key, derives the encryption key from the deterministic values as a short-lived, transient key, and transmits the key securely through the data transport to the requesting application so that the requesting application uses the symmetric key to decrypt the at least one protected data object to return the at least one data object.

16. The cryptographic computer server of claim 14, further comprising a secure cryptographic device configured to add an at least one access policy to the protected data object as an encrypted data block.

17. The cryptographic computer server of claim 15, wherein the decryption engine determines if an at least one access policies added to the protected data object have been met and then proceeds with decryption.

18. The cryptographic computer server of claim 13, wherein a further computing device is configured with the requesting application and executes the application to call the protected data object from the secure storage device, encrypts the at least one data object called from the secure storage device to render the at least one protected data object and then destroy the transient symmetric encryption key and stores the set of deterministic values to recreate the transient symmetric encryption key.

19. The cryptographic computer server of claim 17, wherein a further computing device is configured to operate a decryption engine to execute a set of instructions so that the decryption engine receives a request for decryption, retrieves the set of deterministic values for the transient symmetric encryption key, derives the encryption key from the deterministic values as a short-lived, transient key, and transmits the key securely through the data transport to the requesting application so that the requesting application uses the symmetric key to decrypt the at least one protected data object to return the at least one data object.

20. The cryptographic computer server of claim 18, wherein the decryption engine determines if an at least one access policies added to the protected data object have been met and then proceeds with decryption.

21. The cryptographic computer server of claim 13, wherein the computing device is further configured to execute a secure cryptographic application to add an at least one policy limitation to the protected data object as an encrypted data block.

22. The cryptographic computer server of claim 20, wherein the at least one policy limitation includes an at least one Open by date limitation, a Do Not Open Before date limitation; a Do Not Open After date limitation, an Open By Entities limitation; an Open By Users limitation; an Open By Groups limitation; an Open By Locations limitation; an Open By Devices limitation; a user limitation, a group of limitations, a policy limitation on locations, a policy limitation on devices, an authorized user identifiers list limitation, and a frequency of access limitation.

23. The cryptographic computer server of claim 20, wherein the deterministic values are stored as an at least one data bloc

24. The cryptographic computer server of claim 23, wherein the at least one data block includes an at least one metadata value relating to a set of values representing coefficients for a polynomial or quadratic equation.

25. The cryptographic computer server of claim 24, wherein the at least one metadata value further comprises a blockchain pointer value or node data pointing to a location on the blockchain which stores a set of polynomial or quadratic equation coefficient values as the deterministic value to recreate the transient symmetric encryption key.

26. The cryptographic computer server of claim 13, further comprising a user interface or a user experience configured to receive one or more instructions from a user so as to enable a user to directly select the data object or the protected data object from the secure storage device and communicate inputs to the computing device.

27. The cryptographic computer server of claim 13, wherein the network is a data transport which permits information to flow securely from a client subsystem to a server subsystem and from the server subsystem to the client subsystem through a secure, encrypted channel or layer.

28. The cryptographic computer server of claim 27, wherein the client subsystem securely communicates via the data transport with an API server and thereby executes the request to return the symmetric key to the encryption engine.

29. A computer-implemented method for provisioning a transient cryptographic key for securing a data object as an encrypted, protected data object or decrypting a protected data object in a distributed file system or client server network, said method comprising:
requesting a transient cryptographic key from a client program;
determining if the transient cryptographic key request is for encryption or decryption by analyzing a data block retrieved from the encrypted set of data blocks packaged with the request proceeding with creation of a transient cryptographic key if the request is for an encryption of a data object including the steps of:
communicating with a manifold object subsystem;
accessing a three dimensional manifold having facets in the manifold object subsystem;
selecting an at least one polynomial or quadratic equation having an at least one set of polynomial or quadratic coefficients;
generating an at least one random key seed to generate a unique surface intersection point between the manifold and the at least one polynomial or quadratic equation; and
using the value at that point to save set of identifiers as subcomponent keys in a manifold object table, then generating the transient cryptographic key and returning the generated cryptographic key to the requestor along with an at least one identifier;
returning the cryptographic key for encryption with the at least one identifier, the client program packing the at least one identifier with the encryption on the protected data object;
proceeding with provision of the transient cryptographic key if the request is for a decryption of a data object including the steps of:
communicating with the manifold object subsystem;
receiving an at least one identifier from the protected data object as part of the step of requesting the transient cryptographic key and providing the at least one identifier to the manifold object system;
using the at least one identifier to access the manifold object table associated with the at least one identifier, and return values for the manifold and facets;
using the at least one identifier to regenerate the at least one one polynomial or quadratic equation having an at least one set of polynomial or quadratic coefficients;
regenerating the unique surface intersection point between the manifold and the at least one polynomial or quadratic equation; and
proceeding with recreation of the transient cryptographic key for the request for decryption of a data object.

30. An electronic device for provisioning a transient symmetrical key and deterministic values representing the key, the electronic device comprising interface circuitry, machine-readable instructions and processor circuitry to execute the machine-readable instructions to:
transmit a request from a client computing device configured to encrypt or decrypt a data object using a key and requesting the key in the case of encryption or requesting the key with an at least one subcomponent identifier in the case of decryption;
a computing device configured to receive a request for the key from the client computing device and configured to generate a transient key, in the case of encryption, or regenerating the transient key with the subcomponent identifier in the case of decryption, by determining a set of values for a polynomial or quadratic equation, calculating a manifold with an at least one facet, selecting a point on the at least one facet, solving the polynomial or quadratic equation for an intersection point with the manifold and the selected point on the at least one facet and generating a key based on this solution together with an at least one subcomponent identifier, wherein the key is returned to the client computing device along with the least one subcomponent identifier if the client is encrypting the data object.

31. The computer system of claim 30, wherein the computing device is further configured to process an input request and select a specific three dimensional manifold from several manifolds stored within a manifold engine and retrieve an at least one manifold table object representing the manifold surface and the at least one facet on the surface from the manifold table object.

32. The computer system of claim 30, further configured to generate a random number with a random number generator as an initial key seed then use the initial key seed to select one of the at least one facet on the manifold surface from the at least one manifold table object.

33. The computer system of the claims 32, wherein the computing device is further configured to use the specific three dimensional manifold and the initial key seed to locate a facet location on the three dimensional manifold.

34. The computer system of the claim 30, wherein the solution of the polynomial or quadratic equation for the intersection points further generates a set of polynomial or quadratic equation values.

35. The computer system of the claims 34, wherein encryption/decryption engine uses the surface intersection point solution in combination with the key seed and the polynomial quadratic coefficients to generate a transient encryption key.

36. A key provisioning computing device on a computer network providing a cryptographic key for encryption, comprising:
a computing device configured to receive a request for the key from a client computing device and further configured to generate a transient key by determining a set of values for a polynomial or quadratic equation, calculating a manifold with an at least one facet, selecting a point on the at least one facet, solving the polynomial or quadratic equation for an intersection point with the manifold and the point on the at least one facet and generating a key based on this solution together with an at least one subcomponent identifier, wherein the key is returned to the client computing device along with the least one subcomponent identifier.

37. The key provisioning computing device of claim 113, wherein the computing device is further configured to receive a request for the key from the client computing device and further configured to receive a subcomponent key identifier with the request, regenerate the transient key by recalculating a set of values for the polynomial or quadratic equation, the manifold with an at least one facet, the selected point on the at least one facet, and solving the polynomial or quadratic equation for the intersection point with the manifold and the point on the at least one facet and thereby regenerating the key based on the recalculated solution from the at least one subcomponent identifier, wherein the transient key is returned to the client computing device.
